(19) United States
(12) Patent Application Publication
(10) Pub. No.: US 2026/0147535 A1
(43) Pub. Date: May 28, 2026

(54) ELECTRONIC DEVICE, METHOD, AND NON-TRANSITORY COMPUTER READABLE STORAGE MEDIUM FOR PROVIDING CONTINUOUS COMMAND FUNCTION OF VIRTUAL ASSISTANT

(71) Applicant: SAMSUNG ELECTRONICS CO., LTD., Suwon-si (KR)

(72) Inventors: Hyuk OH, Suwon-si (KR); Jinyeol KIM, Suwon-si (KR); Sungjae PARK, Suwon-si (KR); Seungbeom RYU, Suwon-si (KR); Danbi CHO, Suwon-si (KR); Junho HEO, Suwon-si (KR); Kyungtae KIM, Suwon-si (KR)

(73) Assignee: SAMSUNG ELECTRONICS CO., LTD., Suwon-si (KR)

(21) Appl. No.: 19/453,518

(22) Filed: Jan. 20, 2026

Related U.S. Application Data
(63) Continuation of application No. PCT/KR2025/013022, filed on Aug. 26, 2025.

(30) Foreign Application Priority Data
Aug. 26, 2024 (KR) 10-2024-0114625
Jan. 23, 2025 (KR) 10-2025-0010084

(51) Int. Cl. G06F 3/16; G10L 13/08; G10L 17/00

(52) U.S. Cl. CPC G06F 3/167; G10L 13/08; G10L 17/00

(57) ABSTRACT

An electronic device includes: an input interface configured to receive sound data; memory comprising one or more storage media storing instructions; and at least one processor including processing circuitry, where the instructions, when executed by the at least one processor individually or collectively, may cause the electronic device to: based on a virtual assistant being activated, receive a first voice signal including a first command through the input interface; based on the first voice signal, generate first identification information corresponding to a first speaker of the first voice signal; execute a function corresponding to the first command of the first voice signal; receive a second voice signal including a second command after the first voice signal, through the input interface; and based on the second voice signal, generate second identification information corresponding to a second speaker of the second voice signal.

### CROSS-REFERENCE TO RELATED APPLICATION(S)

This application is a continuation application, claiming priority under 35 U.S.C. § 365(c), of an International application No. PCT/KR2025/013022, filed on Aug. 26, 2025, which is based on and claims the benefit of a Korean patent application number 10-2024-0114625, filed on Aug. 26, 2024, in the Ministry of Intellectual Property, and of a Korean patent application number 10-2025-0010084, filed on Jan. 23, 2025, in the Ministry of Intellectual Property, the disclosure of each of which is incorporated by reference herein in its entirety.

### BACKGROUND

### 1. Field

This disclosure relates to an electronic device, a method, and a non-transitory computer-readable storage medium for providing a continuous command function of a virtual assistant.

### 2. Description of Related Art

An electronic device may obtain a sound signal from the outside through a microphone. For example, the sound signal may include a voice signal uttered by a speaker. For example, the electronic device may provide a virtual assistant (or a virtual assistant function) based on the voice signal.

The above-described information may be provided as a related art for the purpose of helping to understand the present disclosure. No claim or determination is raised as to whether any of the above-described information may be applied as a prior art related to the present disclosure.

### SUMMARY

Aspects will be set forth in part in the description which follows and, in part, will be apparent from the description, or may be learned by practice of the presented embodiments.

According to an aspect of the disclosure, an electronic device may include: an input interface configured to receive sound data; memory comprising one or more storage media storing instructions; and at least one processor including processing circuitry, where the instructions, when executed by the at least one processor individually or collectively, may cause the electronic device to: based on a virtual assistant being activated, receive a first voice signal including a first command through the input interface; based on the first voice signal, generate first identification information corresponding to a first speaker of the first voice signal; execute a function corresponding to the first command of the first voice signal; receive a second voice signal including a second command after the first voice signal through the input interface; based on the second voice signal, generate second identification information corresponding to a second speaker of the second voice signal; and based on a similarity value between the first identification information and the second identification information being greater than or equal to a reference value, execute a function corresponding to the second command of the second voice signal.

According to an aspect of the disclosure, provided is a method performed by an electronic device including an input interface configured to receive sound data, the method may include: based on a virtual assistant being activated, receiving a first voice signal including a first command through the input interface; based on the first voice signal, generating first identification information corresponding to a first speaker of the first voice signal; executing a function corresponding to the first command of the first voice signal; receiving a second voice signal including a second command after the first voice signal through the input interface; based on the second voice signal, generating second identification information corresponding to a second speaker of the second voice signal; and based on a similarity value between the first identification information and the second identification information being greater than or equal to a reference value, executing a function corresponding to the second command of the second voice signal.

According to an aspect of the disclosure, provided is a non-transitory computer-readable storage medium storing one or more programs including instructions that, when individually or collectively executed by at least one processor of an electronic device that includes an input interface configured to receive sound data, may cause the electronic device to: based on a virtual assistant being activated, receive a first voice signal including a first command through the input interface; based on the first voice signal, generate first identification information corresponding to a first speaker of the first voice signal; execute a function corresponding to the first command of the first voice signal; receive a second voice signal including a second command after receiving the first voice signal through the input interface; based on the second voice signal, generate second identification information corresponding to a second speaker of the second voice signal; and based on a similarity value between the first identification information and the second identification information being greater than or equal to a reference value, execute a function corresponding to the second command of the second voice signal.

According to an aspect of the disclosure, an electronic device may include: an input interface configured to receive sound data; memory comprising one or more storage media storing instructions; and at least one processor comprising processing circuitry, where the instructions, when executed by the at least one processor individually or collectively, cause the electronic device to: based on a virtual assistant being activated, receive a first voice signal including a first command through the input interface; based on the first voice signal, generate identification information corresponding to a first speaker of the first voice signal; execute a function corresponding to the first command of the first voice signal; receive a second voice signal including a second command after the first voice signal through the input interface; based on the second voice signal and the identification information, identify whether the first speaker corresponds to a second speaker of the second voice signal; based on the first speaker corresponding to the second speaker, execute a function corresponding to the second command of the second voice signal; and based on the first speaker not corresponding to the second speaker, refrain from executing the function corresponding to the second command of the second voice signal.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A and FIG. 1B illustrate examples of a continuous command function of a virtual assistant, according to various embodiments;

FIG. 2 illustrates an example of a continuous command function of a virtual assistant based on temporary allow, according to an embodiment;

FIG. 3 is a schematic view of an exemplary electronic device, according to an embodiment;

FIG. 4A, FIG. 4B, FIG. 4C, FIG. 4D, FIG. 4E, and FIG. 4F illustrate an example of trained models included in an electronic device, according to various embodiments;

FIG. 5 illustrates an example of an operation flow in which a model for a virtual assistant is trained with respect to a specific user, according to an embodiment;

FIG. 6A illustrates an example of an operation flow for a method of executing, based on a voice signal uttered by a user registered with respect to a virtual assistant, a function corresponding to a command word of the voice signal, according to an embodiment;

FIG. 6B illustrates an example of an operation flow for a method of executing, based on a voice signal uttered by a user registered with respect to a virtual assistant, a function corresponding to a command word of the voice signal, in a continuous command function of the virtual assistant, according to an embodiment;

FIG. 7 illustrates an example of an operation flow for a method of executing, based on a voice signal uttered by a temporary allow user, a function corresponding to a command word of the voice signal, in a continuous command function of a virtual assistant, according to an embodiment;

FIG. 8 illustrates an example of an operation flow for a method of verifying a second user who uttered a second voice signal and a method of executing a function corresponding to a command word of the second voice signal, according to whether a first user who uttered a first voice signal corresponds to a registered user in a continuous command function of a virtual assistant, according to an embodiment;

FIG. 9 illustrates an example of a method of recognizing a voice signal in a continuous command function of a virtual assistant based on temporary allow, according to an embodiment;

FIG. 10 illustrates an example of a user interface for a setting related to a continuous command function of a virtual assistant, according to an embodiment;

FIG. 11 is a block diagram of an electronic device in a network environment according to various embodiments;

FIG. 12 is a block diagram illustrating an integrated intelligence system according to various embodiments;

FIG. 13 is a diagram illustrating a form in which relationship information between a concept and an operation is stored in a database according to various embodiments; and

FIG. 14 is a diagram illustrating a screen in which an electronic device processes a voice input received through an intelligent app according to various embodiments.

### DETAILED DESCRIPTION

Terms used in the present disclosure are used only to describe a specific embodiment, and may not be intended to limit a range of the present disclosure. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

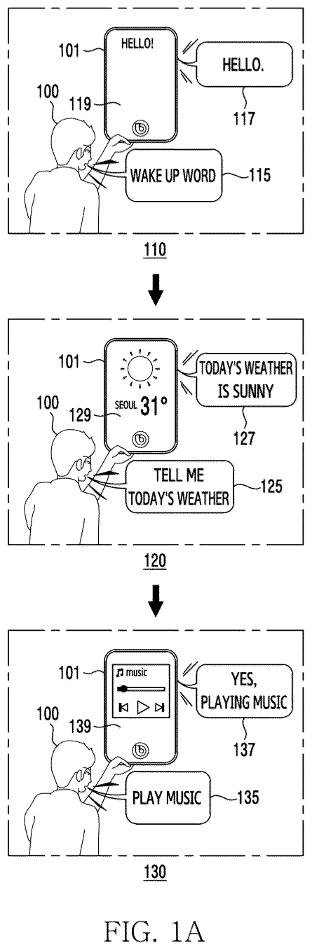

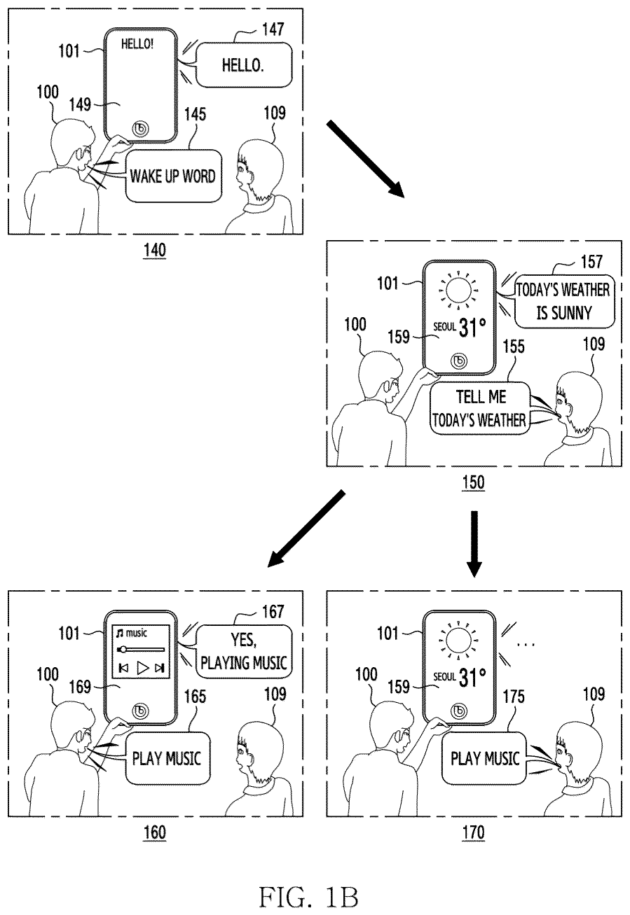

FIGS. 1A and 1B illustrate examples of a continuous command function of a virtual assistant according to various embodiments.

FIGS. 1A and 1B illustrate examples in which an electronic device 101 provides a continuous command function while activating a virtual assistant. For example, the virtual assistant may be a software application (or a software agent) that processes a task requested by a user of the electronic device 101 and provides a service. For example, the virtual assistant may be referred to as a voice assistant, a digital assistant, an intelligent automated assistant, an automatic digital assistant, an artificial intelligence assistant, an intelligent assistant, a personal assistant, a mobile assistant, an intelligent agent, and/or an equivalent technical term. As a non-limiting example, the virtual secretary may include Bixby. However, the present disclosure is not limited thereto.

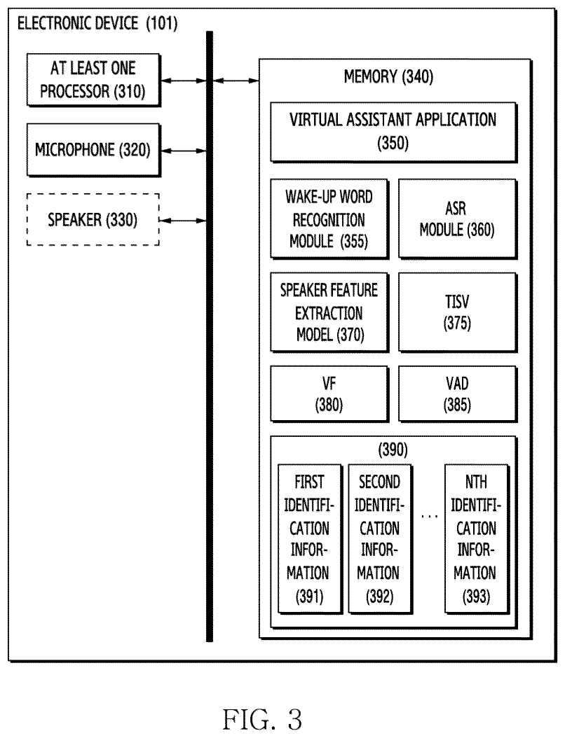

For example, the electronic device 101 may receive a voice signal through a an input interface (e.g., the input interface 320 of FIG. 3). For example, a voice signal (or speech signal) may include a voice. For example, the voice signal may include the voice, noise, or background sound. For example, the voice may be uttered (or spoken) by a user (e.g., the user 100 of FIGS. 1A and 1B) of the electronic device 101 or another user (e.g., the user 109 of FIG. 1B). For example, the voice signal may be referred to as a sound signal, a signal, an utterance signal, or a user signal.

For example, the voice signal may include a wake-up word. For example, the wake-up word may include a word or sentence designated to activate the virtual assistant. For example, activating the virtual assistant may include calling the virtual assistant (or executing a voice recognition function by the virtual assistant) while an application for the virtual assistant (or a virtual assistant application) is executed in the electronic device 101 (or executed in the background of the electronic device 101). For example, the electronic device 101 may activate the virtual assistant in accordance with identifying that the received voice signal includes the wake-up word. In other words, the virtual assistant may be activated in response to the wake-up word. For example, the wake-up word may be referred to as a wake-up voice input, a lexical trigger, a hot-phrase, a hot-word, a trigger word, a trigger phrase, a trigger expression, and/or a similar technical term.

In the example, it is illustrated that the virtual assistant is activated in accordance with receiving a voice signal including the wake-up word, but the present disclosure is not limited thereto. For example, the electronic device 101 may activate the virtual assistant in response to an input with respect to the electronic device 101. For example, the input may include an input for a visual object (or icon) displayed through a physical button of the electronic device 101 or a display of the electronic device 101. For example, the input may be referred to as a user input.

For example, the voice signal may include a command word. For example, the command word may include a word or sentence that causes the activated virtual assistant to execute a specific function. For example, the electronic device 101 may execute a function corresponding to the command word in accordance with identifying that the received voice signal includes the command word while the virtual assistant is activated. For example, executing the function corresponding to the command word may be triggered by the virtual assistant. As a non-limiting example, when the command word is “music playback”, the function may include playing music through a software application providing music. In other words, the function may be executed in response to the command word. For example, the command word may be referred to as a command voice input.

For example, the continuous command function may be a function of the activated virtual assistant. For example, the continuous command function may include executing a function corresponding to the received command word while the virtual assistant is activated, without additional wake-up word recognition (or without additional user input). As a non-limiting example, while the continuous command function of the virtual assistant is executed, the electronic device 101 may execute a function corresponding to a first command word received after the virtual assistant of the electronic device 101 is activated, and again execute a function corresponding to a second command word received without a wake-up word or a user input for activating the virtual assistant. For example, the continuous command function may be referred to as a continuous conversation function, a continuous command mode, a smart follow-up mode, a multiple command function, and/or a similar technical term.

FIG. 1A illustrates examples 110, 120, and 130 in which the electronic device 101 activates a virtual assistant in accordance with receiving a voice signal uttered by a user 100 of the electronic device 101 and executes a function corresponding to a command word while a continuous command function of the virtual assistant is executed. For example, the user 100 of the electronic device 101 may be a user (or speaker) registered with respect to the virtual assistant before the virtual assistant of the electronic device 101 is activated. For example, the registered user (or speaker) may indicate a user (or speaker) capable of performing (or authorizing) the activation of the virtual assistant and execution of a function based on the virtual assistant, within an application providing the virtual assistant (or virtual assistant application). In other words, the registered user may be an allowed (or authorized) user with respect to the virtual assistant.

Referring to the example 110, the user 100 may utter a wake-up word 115 to activate the virtual assistant of the electronic device 101. For example, the electronic device 101 may receive (or obtain) the wake-up word 115 uttered by the user 100 through a microphone. For convenience of explanation, the example 110 illustrates a case where the user 100 utters the wake-up word 115, but the present disclosure is not limited thereto. For example, the user 100 may utter a voice signal including the wake-up word 115. As a non-limiting example, the voice signal uttered by the user 100 may include the wake-up word 115, the wake-up word 115 and a command word, or a word (or a sentence) other than the wake-up word 115 and the command word. For example, the electronic device 101 may recognize (or identify) the wake-up word 115. For example, the electronic device 101 may execute a function corresponding to the wake-up word 115 according to recognizing the wake-up word 115. As a non-limiting example, the function corresponding to the wake-up word 115 may include playing (or outputting) a message 117. As a non-limiting example, the message 117 may include “Hello”. In this disclosure, a function of playing text identified within the electronic device 101 as a voice, such as playing the message 117, may be referred to as text to speech (or TTS playback, playback of TTS composite sound). In addition, as a non-limiting example, the function corresponding to the wake-up word 115 may include displaying a screen 119. As a non-limiting example, the screen 119 may include a dialog window including a visual object indicating the message 117.

Referring to the example 120, the user 100 may utter a command word 125 to execute a function of the electronic device 101 using the virtual assistant of the electronic device 101. For example, the electronic device 101 may receive (or obtain) the command word 125 uttered by the user 100 through a microphone. As a non-limiting example, the command word 125 may include “Tell me today's weather”. As described above, the example 120 illustrates that the electronic device 101 of the example 110 receives the wake-up word 115 and then receives the command word 125 distinct from the wake-up word 115, but the present disclosure is not limited thereto. For example, the electronic device 101 may recognize (or identify) the command word 125. For example, the electronic device 101 may execute a function corresponding to the command word 125 according to recognizing the command word 125. As a non-limiting example, the function corresponding to the command word 125 may include playing (or outputting) a message 127. As a non-limiting example, the message 127 may include “Today's weather is sunny”. In addition, as a non-limiting example, the function corresponding to command word 125 may include displaying a screen 129. As a non-limiting example, the screen 129 may include a screen including a visual object indicating today's weather. As a non-limiting example, the virtual assistant application may cause an application providing weather to display a screen including the visual object indicating today's weather, or obtain and display a screen including the visual object indicating today's weather from an application providing weather.

In the example 110 and the example 120, the electronic device 101 may continuously receive (or obtain) the command word 125 with respect to the wake-up word 115 through the microphone. For example, the command word 125 and the wake-up word 115 may be continuously uttered by the user 100. In this case, the electronic device 101 may skip playing (or outputting) the message 117 in accordance with recognizing the wake-up word 115, and execute the function corresponding to the command word 125.

Referring to the example 130, the user 100 may utter a command word 135 to execute a function of the electronic device 101 by using the virtual assistant of the electronic device 101. For example, the electronic device 101 may receive (or obtain) the command word 135 uttered by the user 100 through a microphone. As a non-limiting example, the command word 135 may include “Play music”. The command word 135 of the example 130 may be received after the command word 125 of the example 120 is received. When the continuous command function of the virtual assistant of the electronic device 101 is being executed, the electronic device 101 may receive the command word 135 without receiving an additional wake-up word. In other words, the electronic device 101 may perform reception of an additional command word (e.g., the command word 135) through a microphone rather than deactivating the virtual assistant after receiving the command word 125 and executing the function corresponding to the command word 125. For example, the electronic device 101 may recognize (or identify) the command word 135. For example, the electronic device 101 may execute a function corresponding to the command word 135 in accordance with recognizing the command word 135. As a non-limiting example, the function corresponding to the command word 135 may include playing (or outputting) a message 137. As a non-limiting example, the message 137 may include “Yes, playing music”. In addition, as a non-limiting example, the function corresponding to the command word 135 may include displaying a screen 139. As a non-limiting example, the screen 139 may include a screen including a visual object indicating music being played. As a non-limiting example, the virtual assistant application may cause an application providing music (or playing music) to display a screen including the visual object indicating the music being played, or obtain and display a screen including the visual object indicating the music being played from the application providing music.

Referring to FIG. 1A, while the continuous command function of the virtual assistant is being executed, the electronic device 101 may receive command words received from the user 100 without receiving an additional wake-up word (or obtaining a user input for activating the virtual assistant) and execute functions corresponding to the command words. The examples 110, 120, and 130 of FIG. 1A illustrate a case in which command words 125 and 135 uttered by the user 100 registered with respect to the virtual assistant are received.

Hereinafter, FIG. 1B illustrates a case in which the electronic device 101 executes functions corresponding to a command word uttered by the registered user 100 and a command word uttered by another user while the continuous command function of the virtual assistant is being executed.

FIG. 1B illustrates examples 140, 150, 160, and 170 in which the electronic device 101 activates the virtual assistant in accordance with receiving a voice signal uttered by the user 100 of the electronic device 101, and executes a function corresponding to a command word in accordance with receiving voice signals uttered by the user 100 and the user 109 while the continuous command function of the virtual assistant is executed. For example, the user 100 of the electronic device 101 may be the registered user (or speaker) with respect to the virtual assistant before the virtual assistant of the electronic device 101 is activated. For example, the user 109 may not be the registered user with respect to the virtual assistant.

Referring to the example 140, the user 100 may utter a wake-up word 145 to activate the virtual assistant of the electronic device 101. For example, the electronic device 101 may receive (or obtain) the wake-up word 145 uttered by the user 100 through a microphone. For example, the electronic device 101 may recognize (or identify) the wake-up word 145. For example, the electronic device 101 may execute a function corresponding to the wake-up word 145 in accordance with recognizing the wake-up word 145. As a non-limiting example, the function corresponding to the wake-up word 145 may include playing (or outputting) a message 147. As a non-limiting example, the message 147 may include “Hello”. In addition, as a non-limiting example, the function corresponding to the wake-up word 145 may include displaying a screen 149. As a non-limiting example, the screen 149 may include a dialog window including a visual object indicating the message 147.

Referring to the example 150, the user 109 may utter a command word 155 to execute a function of the electronic device 101 using the virtual assistant of the electronic device 101. As described above, the user 109 may not be a user registered with respect to the virtual assistant of the electronic device 101. In this case, when the electronic device 101 receives the command word 155 uttered by the user 109 after the virtual assistant is activated by the wake-up word 145 uttered by the user 100, it may be recognized as a situation intended by the user 100. In this case, the command word 155 may be a command word initially received after the virtual assistant is activated. In other words, the electronic device 101 may execute a function corresponding to the command word 155 even when the command word 155 is uttered by the user 109, who is another user, after the virtual assistant is activated by the user 100. For example, the electronic device 101 may receive (or obtain) the command word 155 uttered by the user 109 through a microphone. As a non-limiting example, the command word 155 may include “Tell me today's weather”. For example, the electronic device 101 may recognize (or identify) the command word 155. For example, the electronic device 101 may execute a function corresponding to the command word 155 in accordance with recognizing the command word 155. As a non-limiting example, the function corresponding to the command word 155 may include playing (or outputting) a message 157. As a non-limiting example, the message 157 may include “Today's weather is sunny”. In addition, as a non-limiting example, the function corresponding to the command word 155 may include displaying a screen 159. As a non-limiting example, the screen 159 may include a screen including a visual object indicating today's weather.

Referring to the example 160, the user 100 may utter a command word 165 to execute a function of the electronic device 101 by using the virtual assistant of the electronic device 101. For example, the electronic device 101 may receive (or obtain) the command 165 uttered by user 100 through a microphone. As a non-limiting example, the command word 165 may include “Play music”. The command word 165 of the example 160 may be received after the command word 155 of the example 150 is received. When the continuous command function of the virtual assistant of the electronic device 101 is being executed, the electronic device 101 may receive the command word 165 without receiving an additional wake-up word. In other words, the electronic device 101 may receive an additional command word (e.g., the command word 165) through a microphone, rather than deactivating the virtual assistant after receiving the command word 155 and executing the function corresponding to the command word 155. For example, the electronic device 101 may recognize (or identify) the command word 165. For example, the electronic device 101 may execute a function corresponding to the command word 165 in accordance with recognizing the command word 165. As a non-limiting example, the function corresponding to the command word 165 may include playing (or outputting) a message 167. As a non-limiting example, the message 167 may include “Yes, playing music”. In addition, as a non-limiting example, the function corresponding to the command word 165 may include displaying a screen 169. As a non-limiting example, the screen 169 may include a screen including a visual object indicating music being played.

Referring to example 160, when the continuous command function of the virtual assistant is executed, a function corresponding to the command word 165 uttered by the user 100 registered with respect to the virtual assistant may be executed after the virtual assistant activated by the wake-up word 145 executes the function corresponding to the command word 155, without receiving an additional wake-up word (or user input).

According to an embodiment, referring to the example 170, the user 109 may utter a command word 175 to execute a function of the electronic device 101 using the virtual assistant of the electronic device 101. For example, the electronic device 101 may receive (or obtain) the command word 175 uttered by the user 109 through a microphone. As a non-limiting example, the command word 175 may include “Play music”. The command word 175 of the example 170 may be received after the command word 155 of the example 150 is received. When the continuous command function of the virtual assistant of the electronic device 101 is being executed, the electronic device 101 may receive the command word 175 without receiving an additional wake-up word. In other words, the electronic device 101 may perform reception of an additional command word (e.g., the command word 175) through a microphone, rather than deactivating the virtual assistant after receiving the command word 155 and executing the function corresponding to the command word 155. For example, the electronic device 101 may recognize (or identify) the command word 175. For example, even when the command word 175 is recognized, the electronic device 101 may refrain from (or cease, stop, skip, or bypass) executing the function corresponding to the command word 175 (or may not execute the function corresponding to the command word 175). For example, the electronic device 101 may not recognize the command word 175. Since the user 109 is not a registered user with respect to the virtual assistant such as the user 100, the electronic device 101 may not recognize the command word 175 uttered by the user 109, or may refrain from executing a function corresponding to the command word 175 even when it is recognized. As a non-limiting example, the electronic device 101 may refrain from playing a message in accordance with refraining from executing the function corresponding to the command word 175. In addition, the electronic device 101 may display the screen 159 in accordance with refraining from executing the function corresponding to the command word 175. For example, the screen 159 may be a screen displayed as the function corresponding to the command 155 is executed in the example 150. In other words, the electronic device 101 may maintain displaying the screen 159 displayed according to the function corresponding to the previously received command word 155 rather than displaying the screen 159 as the function corresponding to the command word 175.

Referring to FIG. 1B, while the continuous command function of the virtual assistant is executed, the electronic device 101 may receive command words received from the user 100 without receiving an additional wake-up word (or obtaining a user input for activating the virtual assistant) and execute functions corresponding to the command words. In addition, while the continuous command function of the virtual assistant is being executed, the electronic device 101 may execute a function corresponding to a command word received from the user 109 immediately after being activated according to a wake-up word received from the user 100. However, the electronic device 101 may not execute the function corresponding to the further received command word even when a command word is further received without an additional wake-up word after executing a function corresponding to the command word received from the user 109.

According to an embodiment, the electronic device 101 may receive one wake-up word when receiving one command word from the user 100 who is a user registered with respect to the virtual assistant of the electronic device 101, in order to provide a continuous command function of the virtual assistant. Referring to the above description, the electronic device 101 may receive a wake-up word for each command word or allow only command words by a user registered with respect to the virtual assistant, in order to provide a continuous command function of the virtual assistant. The virtual assistant may be a function of the electronic device 101 that performs a user's work instead. When users execute a continuous command function of the virtual assistant, the users may desire to more naturally converse with the virtual assistant and for continuous commands requested within the conversation to be processed (or performed). However, as wake-up words are required for each command word or only command words by registered users are allowed, a registered user (e.g., the user 100) and an unregistered user (e.g., the user 109) using the continuous command function of the virtual assistant may perceive it as an unnatural (or unsmooth) conversation.

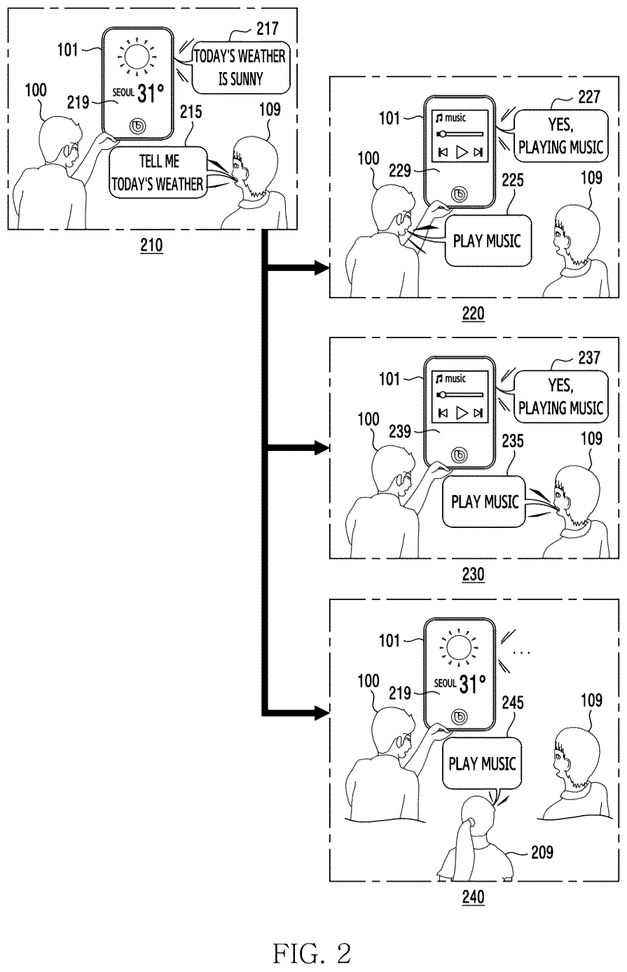

Hereinafter, when the continuous command function of the virtual assistant is being executed, based on temporary allow, an electronic device according to the present disclosure may receive command words of the users without receiving an additional wake-up word (or without receiving user input) and execute a function corresponding to the command words. For example, the temporary allow may indicate that other users, in addition to the registered user, are temporarily provided with the same authority as the registered user. For example, the temporary allow may be referred to as on-the-fly registration. Accordingly, the virtual assistant according to the present disclosure may provide a more natural and smooth user experience. In other words, the present disclosure may process command words uttered by multiple users in a continuous conversational manner by extending the authority provided only to a registered user (or speaker) to a temporarily allowed user (or speaker). In addition, the present disclosure may more accurately receive and process a voice signal uttered by a temporarily allowed user (or speaker) other than a registered user (or speaker). Accordingly, in an environment where multiple speakers exist, the present disclosure may accurately recognize command words uttered by a temporarily allowed user as well as a registered user, and provide a function accordingly. An example of the continuous command function of the virtual assistant based on temporary allow is exemplified and described below with reference to FIG. 2.

FIG. 2 illustrates an example of a continuous command function of a virtual assistant based on temporary allow.

FIG. 2 illustrates examples 210, 220, 230, and 240 in which the electronic device 101 executes a function corresponding to a command word while a continuous command function of a virtual assistant is executed, in accordance with activating the virtual assistant by receiving a voice signal uttered by a user 100 of the electronic device 101, and receiving voice signals uttered by the user 100 who is a registered user with respect to the virtual assistant and a user 109 who is a temporarily allowed user. For example, the user 100 of the electronic device 101 may be the registered user (or speaker) with respect to the virtual assistant before the virtual assistant of the electronic device 101 is activated. For example, the user 109 may not be the registered user with respect to the virtual assistant, but may be a temporarily allowed user. For example, the temporarily allowed user may be a user who uttered a command word initially received after the virtual assistant is activated. As a non-limiting example, the temporary allowed user may correspond to a portion of the registered users. For example, the temporary allowed user corresponding to the registered user may indicate that the temporary allowed user is included in the registered users or coincides with (or is identical to) a portion of the registered users.

The user 100 may utter a wake-up word to activate the virtual assistant of the electronic device 101. For example, the electronic device 101 may receive (or obtain) a wake-up word uttered by the user 100 through a microphone. For example, the electronic device 101 may recognize (or identify) a wake-up word. For example, the electronic device 101 may activate the virtual assistant in accordance with recognizing the wake-up word. For specific details related thereto, the example 110 of FIG. 1A or the example 140 of FIG. 1B may be referred to. Hereinafter, redundant descriptions are omitted. In addition, the electronic device 101 may receive a user input for activating the virtual assistant instead of receiving the wake-up word. For example, the electronic device 101 may activate the virtual assistant in accordance with receiving the user's input.

Referring to the example 210, the user 109 may utter a command word 215 to execute a function of the electronic device 101 by using the virtual assistant of the electronic device 101. As described above, the user 109 may not be a user registered with respect to the virtual assistant of the electronic device 101. In this case, the electronic device 101 may receive the command word 215 uttered by the user 109 after the virtual assistant is activated. For example, the command word 215 may be a command word initially received after the virtual assistant is activated. For example, the electronic device 101 may receive (or obtain) the command word 215 uttered by the user 109 through a microphone. As a non-limiting example, the command word 215 may include “Tell me today's weather”. For example, the electronic device 101 may recognize (or identify) the command word 215. For example, the electronic device 101 may execute a function corresponding to the command word 215 in accordance with recognizing the command word 215. As a non-limiting example, the function corresponding to the command word 215 may include playing (or outputting) a message 217. As a non-limiting example, the message 217 may include “Today's weather is sunny”. In addition, as a non-limiting example, the function corresponding to the command word 215 may include displaying a screen 219. As a non-limiting example, the screen 219 may include a screen including a visual object indicating today's weather.

Referring to the example 220, the user 100 may utter a command word 225 to execute a function of the electronic device 101 by using the virtual assistant of the electronic device 101. For example, the electronic device 101 may receive (or obtain) the command word 225 uttered by the user 100 through a microphone. As a non-limiting example, the command word 225 may include “Play music”. The command word 225 of the example 220 may be received after the command word 215 of the example 210 is received. When the continuous command function of the virtual assistant of the electronic device 101 is being executed, the electronic device 101 may receive the command word 225 without receiving an additional wake-up word. In other words, the electronic device 101 may perform reception of an additional command word (e.g., the command word 225) through a microphone, rather than deactivating the virtual assistant after receiving the command word 215 and executing the function corresponding to the command word 215. For example, the electronic device 101 may recognize (or identify) the command word 225. For example, the electronic device 101 may execute the function corresponding to the command word 225 in accordance with recognizing the command word 225. As a non-limiting example, the function corresponding to the command word 225 may include playing (or outputting) a message 227. As a non-limiting example, the message 227 may include “Yes, playing music”. In addition, as a non-limiting example, the function corresponding to the command word 225 may include displaying a screen 229. As a non-limiting example, the screen 229 may include a screen including a visual object indicating music being played.

Referring to the example 230, the user 109 may utter a command word 235 to execute a function of the electronic device 101 by using the virtual assistant of the electronic device 101. For example, the electronic device 101 may receive (or obtain) the command word 235 uttered by the user 109 through a microphone. As a non-limiting example, the command word 235 may include “Play music”. The command word 235 of the example 230 may be received after the command word 215 of the example 210 is received. When the continuous command function of the virtual assistant of the electronic device 101 is being executed, the electronic device 101 may receive the command word 235 without receiving an additional wake-up word. In other words, the electronic device 101 may perform reception of an additional command word (e.g., the command word 235) through a microphone, rather than deactivating the virtual assistant after receiving the command word 215 and executing the function corresponding to the command word 215. For example, the electronic device 101 may recognize (or identify) the command word 235. For example, the electronic device 101 may execute the function corresponding to the command word 235 by recognizing the command word 235. As a non-limiting example, the function corresponding to the command word 235 may include playing (or outputting) a message 237. As a non-limiting example, the message 237 may include “Yes, playing music”. In addition, as a non-limiting example, the function corresponding to command word 235 may include displaying a screen 239. As a non-limiting example, the screen 239 may include a screen including a visual object indicating music being played.

Unlike FIG. 1B, referring to FIG. 2, since the user 109 is a user who utters the command word 215 initially received after the virtual assistant is activated, the electronic device 101 may temporarily allow the user 109 with respect to the virtual assistant. As a non-limiting example, the electronic device 101 may generate identification information indicating the user 109 who utters the command word 215. For example, the identification information may include a vector value indicating the user 109. For example, the electronic device 101 may use the identification information indicating the user 109 to identify whether additional received command words (e.g., the command word 235) are command words uttered by the user 109. Accordingly, the electronic device 101 may execute functions corresponding to command words (e.g., the command word 235), which are uttered by the user 109 and additionally received.

According to an embodiment, referring to the example 240, the user 209 may utter the command word 245 to execute a function of the electronic device 101 by using the virtual assistant of the electronic device 101. For example, the electronic device 101 may receive (or obtain) the command word 245 uttered by the user 109 through a microphone. As a non-limiting example, the command word 245 may include “Play music”. The command word 245 of the example 240 may be received after the command word 215 of the example 210 is received. When the continuous command function of the virtual assistant of the electronic device 101 is being executed, the electronic device 101 may receive the command word 245 without receiving an additional wake-up word. In other words, the electronic device 101 may perform reception of an additional command word (e.g., the command word 245) through a microphone, rather than deactivating the virtual assistant after receiving the command word 215 and executing the function corresponding to the command word 215. For example, the electronic device 101 may recognize (or identify) the command word 245. For example, even when the command word 245 is recognized, the electronic device 101 may refrain from (or cease, stop, skip, or bypass) executing the function corresponding to the command word 245 (or may not execute the function corresponding to the command word 245). For example, the electronic device 101 may not recognize the command word 245. Since the user 209 is not a user designated with respect to the virtual assistant, the electronic device 101 may not recognize the command word 245 uttered by the user 209, or may refrain from executing a function corresponding to the command word 245 even when it is recognized. In the present disclosure, the designated user may include a user registered with respect to the virtual assistant, such as the user 100, and a user temporarily allowed with respect to the virtual assistant, such as the user 109. As a non-limiting example, the electronic device 101 may refrain from playing a message in accordance with refraining from executing the function corresponding to the command word 245. In addition, the electronic device 101 may display the screen 219 in accordance with refraining from executing the function corresponding to the command word 245. For example, the screen 219 may be a screen displayed as the function corresponding to command word 215 is executed in the example 210. In other words, the electronic device 101 may maintain displaying the screen 219 displayed according to the function corresponding to the previously received command word 215 rather than displaying the screen 219 as the function corresponding to the command word 245.

Referring to FIG. 2, while the continuous command function of the virtual assistant is executed, the electronic device 101 may receive command words received from the user 100 and the user 109 without receiving an additional wake-up word (or obtaining a user input for activating the virtual assistant) and execute functions corresponding to the command words. In other words, while the continuous command function of the virtual assistant is being executed, the electronic device 101 may execute functions corresponding to commands received from a temporary allowed user as well as a registered user with respect to the virtual assistant.

FIG. 3 is a schematic view of an exemplary electronic device.

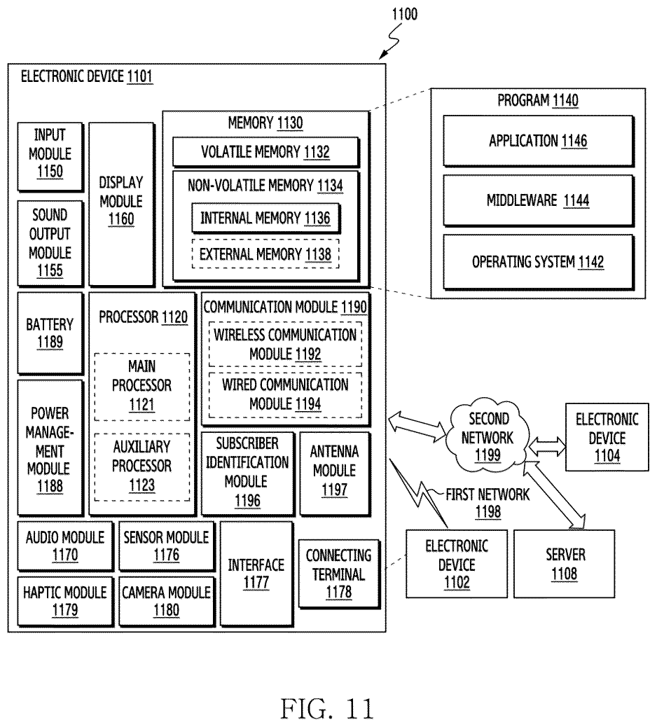

FIG. 3 illustrates an example of the electronic device 101. The electronic device 101 of FIG. 3 may be an example of the electronic device 1101 of FIG. 11. For example, the electronic device 101 may include at least a portion of the electronic device 1101, or may correspond to at least a portion of the electronic device 1101.

For example, the electronic device 101 may be implemented with various form factors. For example, the electronic device 101 may include an electronic device having the bar-type display as well as an electronic device having the display that is a flexible display. For example, the electronic device (101) including the flexible display may include an electronic device including a foldable display, an electronic device including a multi-foldable display, or an electronic device including a rollable display. In addition, for example, the electronic device 101 may include a tablet PC. In addition, for example, the electronic device 101 may be implemented as a wearable device. For example, the wearable device may include a head mounted display (HMD) or a watch-shaped device. However, the present disclosure is not limited thereto.

Referring to FIG. 3, according to an embodiment, the electronic device 101 may include at least one processor 310, an input interface 320, a speaker 330, and memory 340. However, embodiments of the present disclosure are not limited thereto. For example, the at least one processor 310, the input interface 320, the speaker 330, and the memory 340 may be electronically and/or operably coupled with each other by a communication bus. Hereinafter, hardware components being operably coupled may mean that a direct or indirect connection between hardware components is established by wire or wirelessly so that a second hardware component is controlled by a first hardware component among the hardware components. Although illustrated based on different blocks, but the embodiment is not limited thereto, and a portion (e.g., at least a portion of the at least one processor 310 and the memory 340) of hardware components illustrated in FIG. 3 may be included in a single integrated circuit such as a system on a chip (SoC) or a system in package (SIP). The type and/or number of hardware components included in the electronic device 101 is not limited as illustrated in FIG. 3. For example, the electronic device 101 may include only a portion of the hardware components illustrated in FIG. 3. For example, the electronic device 101 may not include the speaker 330.

According to an embodiment, the at least one processor 310 of the electronic device 101 may include a hardware component for processing data based on one or more instructions. For example, the hardware component for processing data may include an arithmetic and logic unit (ALU), a floating point unit (FPU), and a field programmable gate array (FPGA). For example, the hardware component for processing data may include a central processing unit (CPU), a graphics processing unit (GPU), a digital signal processing (DSP), a microcontroller (MCU), and/or a neural processing unit (NPU). The number of at least one processor 310 may be one or more. For example, the at least one processor 310 may have a multi-core processor structure such as a dual core, a quad core, or a hexa core. The contents of the processor 1120 of FIG. 11 may be applied to the at least one processor 310 of FIG. 3 in substantially the same manner.

For example, the at least one processor 310 may include various processing circuits and/or multiple processors. For example, the term “processor” used in this document, including the scope of claims, may include various processing circuits including at least one processor, and one or more of the at least one processor may be configured to perform individually and/or collectively various functions described below in a distributed manner. As used below, when “processor”, “at least one processor”, and “one or more processors” are described as configured to perform various functions, these terms are not limited to examples and but include situations in which one processor performs a portion of cited functions and another processor(s) performs another portion of the cited functions, and situations in which one processor may perform all of the cited functions. Additionally, for example, the at least one processor may include a combination of processors that perform various functions enumerated/disclosed in a distributed manner. The at least one processor may execute program instructions to achieve or perform various functions.

According to an embodiment, the electronic device 101 may include an input interface 320 configured to receive sound data. For example, the input interface may include a microphone for obtaining sound (e.g., voice, noise, audio) from the outside of the electronic device 101. According to an embodiment, the microphone may be integrated as a component of the electronic device 101, or may be implemented as an external microphone that is wiredly or wirelessly connected the electronic device 101. As a non-limiting example, the input interface 320 may include at least one microphone. The microphone may be a digital microphone, an electronic condenser microphone (ECM), a micro electro mechanical system (MEMS), and the like, but is not limited thereto. The contents of the input module 1150 of FIG. 11 may be substantially equally applied to the specific contents of the input interface 320 of FIG. 3.

According to an embodiment, the electronic device 101 may include the speaker 330 for outputting audio information (e.g., sound or audio data). As a non-limiting example, the audio information outputted through the speaker 330 may include TTS outputted when playing TTS composite sound based on execution of a virtual assistant application 350 of the electronic device 101. However, the present disclosure is not limited thereto. The contents of the audio output module 1155 (and/or the audio module 1170) of FIG. 11 may be substantially equally applied to the specific contents of the speaker 330 of FIG. 3.

According to an embodiment, the electronic device 101 may include the memory 340. The memory 340 may include a hardware component for storing data and/or instructions inputted to and/or outputted from the at least one processor 310. For example, the memory 340 may include a volatile memory, such as a random-access memory (RAM), and/or a non-volatile memory, such as a read-only memory (ROM). For example, the volatile memory may include at least one of dynamic RAM (DRAM), static RAM (SRAM), Cache RAM, and pseudo SRAM (PSRAM). For example, the nonvolatile memory may include at least one of programmable ROM (PROM), erasable PROM (EPROM), electrically erasable PROM (EEPROM), flash memory, hard disk, compact disk, and embedded multimedia card (eMMC). The contents of the memory 1130 of FIG. 11 may be substantially equally applied to the specific contents of the memory 340 of FIG. 3.

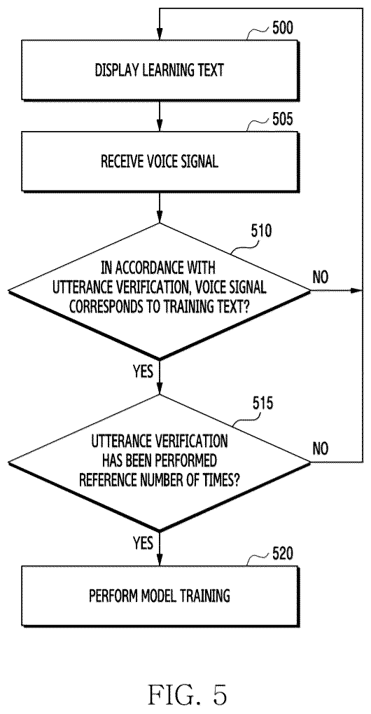

According to an embodiment, one or more instructions (or command words) indicating a calculation and/or an operation to be performed on data by the at least one processor 310 of the electronic device 101 may be stored in the memory 340 of the electronic device 101. A set of the one or more instructions may be referred to as a program, firmware, an operating system, a process, a routine, a sub-routine, and/or an application. Hereinafter, an application being installed in an electronic device (e.g., the electronic device 101) may mean that one or more instructions provided in a form of an application are stored in the memory 340, and that the one or more applications are stored in a format (e.g., a file having an extension specified by an operating system of the electronic device 101) executable by a processor of the electronic device. According to an embodiment, the electronic device 101 may perform operations of FIGS. 5 to 8 by executing the one or more instructions stored in the memory 340. For example, the one or more instructions, when executed by the at least one processor 310, may cause the electronic device 101 to perform at least a portion of operations of FIGS. 5 to 8.

The electronic device 101 may include a display. For example, the display may be used to display a screen to be displayed based on execution of the virtual assistant application 350 of the electronic device 101. For example, the content of the display module 1160 of FIG. 11 below may be substantially equally applied to the specific content of the display. In addition, the electronic device 101 may include a module for power supply. For example, the electronic device 101 may include a battery. The content of the battery 1189 of FIG. 11 may be substantially equally applied to the specific content of the battery.

For example, the memory 340 may include (or store) the virtual assistant application 350. For example, the virtual assistant application 350 may be referred to as an application for providing a virtual assistant. The electronic device 101 may periodically (or aperiodically) receive a voice signal through the input interface 320 by executing the virtual assistant application 350 (or executing the virtual assistant application 350 in the background). For example, the electronic device 101 may activate the virtual assistant in accordance with recognizing that a wake-up word is included in a voice signal received through the input interface 320. In other words, the electronic device 101 may activate the virtual assistant, which has been deactivated while executing the virtual assistant application 350, in accordance with recognizing the wake-up word.

For example, the memory 340 may include (or store) a wake-up word recognition module 355. For example, the wake-up word recognition module 355 may be used to determine (or identify, recognize) whether a wake-up word is included in a voice signal received through the input interface 320. As a non-limiting example, the wake-up word recognition module 355 may be used to determine only whether a wake-up word is included in a voice signal. As a non-limiting example, the wake-up word recognition module 355 may be used to determine whether a wake-up word is included in a voice signal and whether the wake-up word is uttered by a designated user. The designated user may include a user registered with respect to the virtual assistant and a user temporarily allowed with respect to the virtual assistant. For example, the wake-up word recognition module 355 that determines whether a wake-up word is included in a voice signal and whether a wake-up word is uttered by the designated user may be referred to as a text-dependent speaker verification (TDSV). For example, the TDSV may be a model trained to recognize a user who uttered a specific word (e.g., wake-up word). For example, a description of a text-independent speaker verification (TISV) 375 below may be substantially equally applied to the description of the TDSV.

For example, the memory 340 may include (or store) an automatic speech recognition (ASR) module 360. For example, the ASR module 360 may be used to convert a voice signal received through the input interface 320 into text. For example, the text may include characters indicating a voice portion in the voice signal. For example, the text may include a wake-up word, or a wake-up word and a command word. The electronic device 101 may analyze the intent of the user (or speaker) who uttered the voice signal from the text through natural language understanding (NLU). For example, the electronic device 101 may recognize the intent of the user by analyzing the text converted from the voice signal based on NLU.

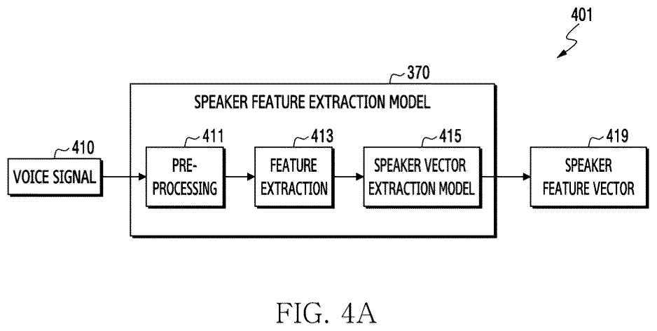

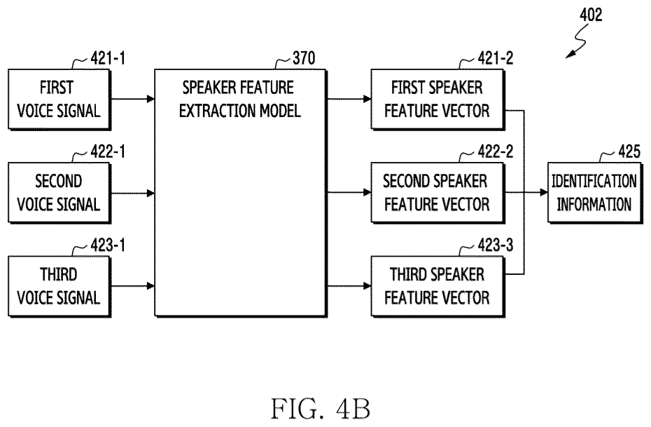

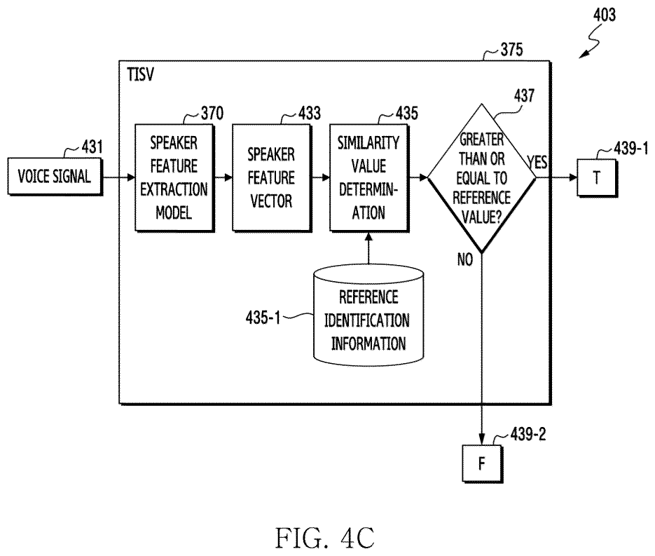

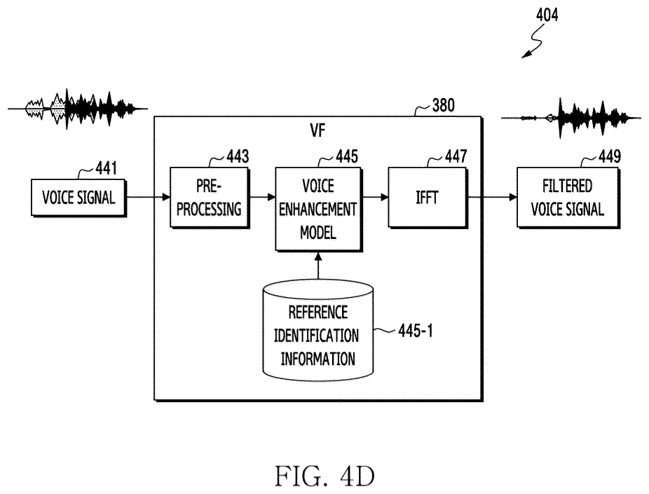

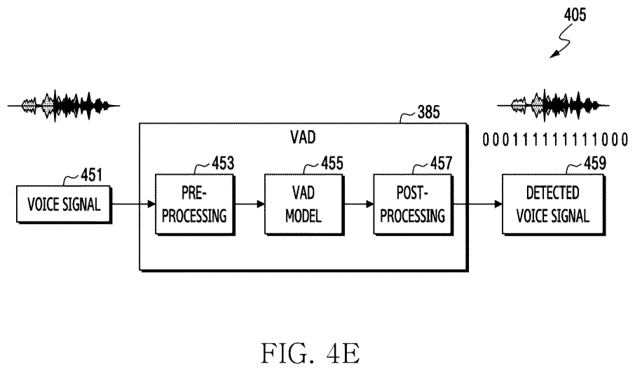

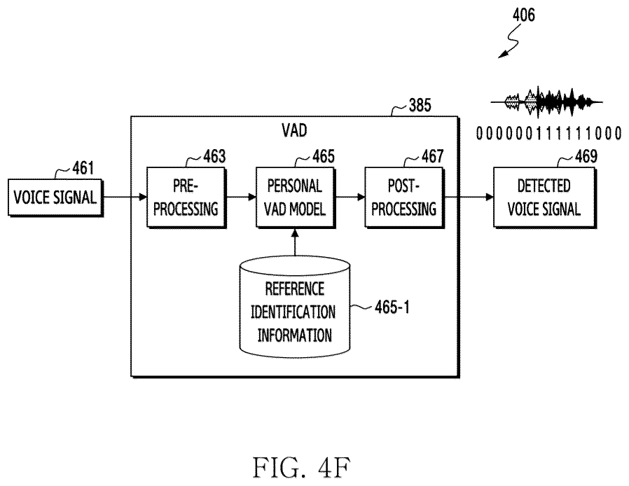

For example, the memory 340 may include (or store) a speaker feature extraction model 370. For example, the speaker feature extraction model 370 may be referred to as a model trained for speaker feature extraction. For example, the speaker feature extraction model 370 may be used to generate identification information indicating a user who uttered a voice signal, based on the voice signal received through the input interface 320. As a non-limiting example, the identification information may include at least one vector value indicating the user. For example, a vector value indicating a user may be referred to as an embedding, an embedding vector, a speaker feature vector, a speaker feature value, or a speaker model. In FIG. 3, the speaker feature extraction model 370 may be included (or implemented) in the TISV 375 (or the TDSV). For specific details on the speaker feature extraction model 370, FIGS. 4A and 4B may be referred to.

For example, the memory 340 may include the TISV 375. The TISV 375 may be referred to as a model trained for speaker verification. For example, the TISV 375 may be used to generate identification information indicating a user who uttered the voice signal based on a voice signal received through the input interface 320, and to determine (or identify, check, verify) whether the user indicated by the identification information is corresponding to (or is identical to, or coincides with) a user indicated by identification information used as a reference. The identification information used for the reference may be referred to as reference identification information. As a non-limiting example, the reference identification information may include a vector value indicating the user. For specific details on the TISV 375, FIG. 4C may be referred to.

For example, the memory 340 may include (or store) a voice filter (VF) 380. The VF 380 may be referred to as a trained model for voice filtering. For example, the VF 380 may be used to filter (or identify, detect) a voice portion within a voice signal based on the voice signal received through the input interface 320. As a non-limiting example, the VF 380 may be used to filter a voice portion uttered by a user indicated by identification information used as a reference within the voice signal. Filtering the voice portion within the voice signal may include suppressing (or deleting, reducing) another portion (e.g., noise, another user's voice portion) other than the voice portion within the voice signal. For specific details on the VF 380, FIG. 4D may be referred to.

For example, the memory 340 may include (or store) a voice activity detection (VAD) 385. For example, the VAD 385 may be referred to as a trained model for voice activity detection. As a non-limiting example, the VAD 385 may be used to detect a voice portion within a voice signal received through the input interface 320. As a non-limiting example, the VAD 385 may output a voice portion within the voice signal as 1 and a non-voice portion within the voice signal as 0. For specific details on the VAD 385 independent of a specific user, FIG. 4E may be referred to. For specific details on the VAD 385 dependent on a specific user, FIG. 4F may be referred to. The VAD 385 dependent on a specific user may replace or complement the TISV 375, in terms of detecting a voice portion of a specific user. The VAD 385 may be end-point detection (EPD). For example, the EPD may be used to detect a portion (or timing) at which a voice portion ends in the voice signal.

For example, the memory 340 may include (or store) identification information set 390. For example, the identification information set 390 may include first identification information 391, second identification information 392, and up to n-th identification information 393. FIG. 3 illustrates the identification information set 390 including three or more identification information, but the present disclosure is not limited thereto. For example, the identification information set 390 may include two or fewer identification information. For example, identification information included in the identification information set 390 may indicate a designated user. As a non-limiting example, the first identification information 391 may indicate a user registered with respect to the virtual assistant. As a non-limiting example, the second identification information 392 may indicate a user temporarily allowed with respect to the virtual assistant.

In the above example, when the second identification information 392 indicates a temporarily allowed user, the second identification information 392 may be deleted in the identification information set 390 (or the memory 340 in the electronic device 101) as the specified event is identified. As a non-limiting example, the specified event may include at least one of a deactivation of the activated virtual assistant, a deactivation of a continuous command function of the virtual assistant, or an identification that a user indicated by the second identification information 392 coincides with a user registered with respect to the virtual assistant (e.g., the user indicated by the first identification information 391). The above example illustrates that the second identification information 392 indicating the temporarily allowed user is stored in a storage space of the memory 340 (e.g., the identification information set 390 within the memory 340), but the present disclosure is not limited thereto. For example, the second identification information 392 indicating the temporarily allowed user may be stored in another storage space of the memory 340. As a non-limiting example, the other storage space may be referred to as a storage space for temporary storage (or caching).

Although the aspects of the memory 340 are illustrated separately, it should be understood that two or more of these elements, modules or units may be combined into one single element, module or unit which performs all operations or functions of the combined two or more elements, modules or units. Also, at least part of functions of at least one of these elements, modules or units may be performed by another of these elements, modules or units.

Hereinafter, in the present disclosure, providing a signal to a model (e.g., the speaker feature extraction model 370, the TISV 375, the VF 380, and the VAD 385) may refer to inputting an input signal (or input data) to a model, using it as an input, or feeding it. In addition, in the present disclosure, generating a signal from a model (e.g., a the speaker feature extraction model 370, the TISV 375, the VF 380, and the VAD 385) may refer to outputting an output signal (or output data) from a model, using it as an output, or obtaining it.

FIGS. 4A to 4F illustrate an example of trained models included in an electronic device.

FIGS. 4A and 4B illustrate an example of the speaker feature extraction model 370 included in the electronic device 101 (or the memory 340) of FIG. 3. Referring to FIG. 4A, an example 401 of a method in which the speaker feature extraction model 370 generates a speaker feature vector 419 based on a received voice signal 410. Referring to FIG. 4B, an example 402 of a method in which the speaker feature extraction model 370 generates identification information based on a plurality of voice signals is illustrated.

Referring to the example 401, the electronic device 101 may provide (or feed, input) a voice signal 410 to the speaker feature extraction model 370. For example, the voice signal 410 may be received through the input interface 320 of the electronic device 101.

For example, the speaker feature extraction model 370 may perform preprocessing 411 on the provided voice signal 410. As a non-limiting example, the preprocessing 411 may include amplification for a magnitude of the voice signal 410. As a non-limiting example, the preprocessing 411 may include normalization for the voice signal 410. As a non-limiting example, the preprocessing 411 may include a noise delete for the voice signal 410.

For example, the speaker feature extraction model 370 may perform feature extraction 413 on the voice signal 410 (hereinafter, the preprocessed voice signal 410) in which the preprocessing 411 is performed. For example, the feature extraction 413 may convert the pre-processed voice signal 410 into a vector. For example, the vector converted from the preprocessed voice signal 410 may be data indicating a voice of the voice signal 410. The amount of data of the preprocessed voice signal 410 may be reduced in accordance with the feature extraction 413. As a non-limiting example, the feature extraction 413 may include mel-frequency cepstral coefficients (MFCC). As a non-limiting example, the feature extraction 413 may include a log-mel filter bank. As a non-limiting example, the feature extraction 413 may include linear predictive coding (LPC). As a non-limiting example, the feature extraction 413 may include a spectrogram.

For example, the speaker feature extraction model 370 may generate (or output) a speaker feature vector 419, by using the voice signal 410 on which the feature extraction 413 is performed (hereinafter, extracted voice signal 410). For example, the speaker vector extraction model 415 may be used to generate the speaker feature vector 419 to indicate a user (or speaker) who uttered the voice signal 410 on inputted data (e.g., vector or the extracted voice signal 410). For example, the speaker vector extraction model 415 may use modeling. As a non-limiting example, the speaker vector extraction model 415 may use a Gaussian mixture model (GMM) supervector. As a non-limiting example, the speaker vector extraction model 415 may use i-vector. Or, for example, the speaker vector extraction model 415 may use deep-learning.

As a non-limiting example, the speaker feature extraction model 370 may be included in the TISV 375 or the TDSV. The speaker feature extraction model 370 included in the TISV 375 may generate a speaker feature vector 419 indicating a user who uttered the voice signal 410, regardless of a word or a sentence included in the voice signal 410. The speaker feature extraction model 370 included in the TDSV may recognize a specific word or a specific sentence included in the voice signal 410 and generate a speaker feature vector 419 indicating a user who uttered the voice signal 410.

As described above, the speaker feature extraction model 370 may store (or register) identification information for a specific speaker in the memory 340, by generating the identification information, based on at least one voice signal of the specific speaker. For specific details related thereto, FIG. 4B may be referred to.

Referring to example 402, the electronic device 101 may provide (or feed, input) at least one voice signal to the speaker feature extraction model 370. In the example 402, the at least one voice signal 410 may include a first voice signal 421-1, a second voice signal 422-1, and a third voice signal 423-1. For convenience of explanation, FIG. 4B illustrates that three voice signals is provided to the speaker feature extraction model 370, but the present disclosure is not limited thereto.

For example, the speaker feature extraction model 370 may generate (or output) at least one speaker feature vector based on the at least one voice signal. For example, the at least one speaker feature vector 419 may include a first speaker feature vector 421-2, a second speaker feature vector 422-2, and a third speaker feature vector 423-2. The generation of a speaker feature vector by the speaker feature extraction model 370 based on the voice signal may be referred to FIG. 4A.

For example, identification information 425 may be identified based on the first speaker feature vector 421-2, the second speaker feature vector 422-2, and the third speaker feature vector 423-2. For example, the identification information 425 may be identified as a representative value (e.g., mean value, median value) of the first speaker feature vector 421-2, the second speaker feature vector 422-2, and the third speaker feature vector 423-2.

The example of FIG. 4B illustrates that three speaker feature vectors constitute the identification information 425, but the present disclosure is not limited thereto. For example, the identification information 425 may be configured with one speaker feature vector. In addition, FIG. 4B illustrates that one voice signal is outputted as one speaker feature vector, but the present disclosure is not limited thereto. For example, one voice signal may be used to output a plurality of speaker feature vectors, and one voice signal may be distinguished into a plurality of voice signals and the plurality of distinguished voice signals may be used to output a plurality of speaker feature vectors. For example, when one voice signal is distinguished into a plurality of voice signals, one voice signal may be distinguished by each word within the one voice signal, or a time length constituting the one voice signal may be distinguished by each specific time length (or frame).

FIG. 4B illustrates an example 402 of generating identification information 425 based on at least one voice signal using the speaker feature extraction model 370. Accordingly, the electronic device 101 may generate the identification information 425 indicating a user who uttered the at least one voice signal. At this time, generating (or storing) the identification information 425 may be referred to as registering the user with respect to the virtual assistant application 350. After registering the user with the virtual assistant application 350, the electronic device 101 may analyze a voice signal received from the user while the virtual assistant is activated, and recognize that the voice signal is uttered by the user by using the identification information 425. For specific details related thereto, FIG. 4C may be referred to.

FIG. 4C illustrates an example of the TISV 375 included in the electronic device 101 (or the memory 340) of FIG. 3. Referring to FIG. 4C, an example 403 of a method for determining the similarity between a user who uttered a voice signal 431 and a user indicated by reference identification information 435-1 based on the received voice signal 431 is illustrated. In the example 403, for convenience of explanation, a method of determining the similarity between a user who uttered the voice signal 431 and a user indicated by the reference identification information 435-1 by using the TISV 375 is illustrated, but the present disclosure is not limited thereto. The contents of the TISV 375 may be substantially equally applied to the TDSV.

Referring to the example 403, the TISV 375 may include the speaker feature extraction model 370. For example, the electronic device 101 may provide the voice signal 431 received through the input interface 320 to the speaker feature extraction model 370. For example, the speaker feature extraction model 370 of the TISV 375 may generate a speaker feature vector 433 indicating a user who uttered the voice signal 431.

For example, the TISV 375 may perform similarity value identification 435 based on the speaker feature vector 433 and the reference identification information 435-1. For example, the similarity value identification 435 may indicate identifying a similarity value between the speaker feature vector 433 generated based on the voice signal 431 and the reference identification information 435-1 used as a reference. As a non-limiting example, the TISV 375 may include a model trained for identifying similarity values, or a module for an operation for identifying similarity values. For example, the module may be referred to as an algorithm for the operation, rather than using a trained model. In other words, the similarity value identification 435 may be performed by an operation of the at least one processor 310 without the TISV 375. For example, the reference identification information 435-1 may be identification information in the identification information set 390 stored in the memory 340. For example, the reference identification information 435-1 may indicate a designated user (e.g., a registered user or a temporarily allowed user) with respect to the virtual assistant. As a non-limiting example, the reference identification information 435-1 may include a plurality of identification information corresponding to a plurality of users. In an example, the reference identification information 435-1 may include identification information corresponding to a first registered user, identification information corresponding to a second registered user, and identification information corresponding to a temporarily allowed user.

For example, the TISV 375 may perform a comparison 437 between the similarity value outputted in accordance with the similarity value identification 435 and a reference value. For example, the reference value may be a value for determining whether a user who uttered the voice signal 431 is corresponding to (or is identical to, or coincides with) a user indicated by the reference identification information 435-1. For example, the TISV 375 may output a first value 439-1 when the similarity value is greater than or equal to the reference value in accordance with the comparison 437. In contrast, the TISV 375 may output a second value 439-2 when the similarity value is less than the reference value in accordance with the comparison 437. For example, the first value 439-1 may indicate that the user who uttered the voice signal 431 is corresponding to the user indicated by the reference identification information 435-1. For example, the second value 439-2 may indicate that the user who uttered the voice signal 431 does not correspond to (or is different from) the user indicated by the reference identification information 435-1. As a non-limiting example, the first value 439-1 may be ‘True’. As a non-limiting example, the second value 439-2 may be ‘False’. As a non-limiting example, the comparison 437 and output of a result according to the comparison 437 may be performed by an operation of the at least one processor 310 without the TISV 375.

As described above, the electronic device 101 may determine (or decide, identify, verify) whether the user who uttered the voice signal 431 is corresponding to (or is identical to, or coincides with) the user indicated by the reference identification information 435-1 using the outputted result (e.g., the first value 439-1 or the second value 439-2), by providing the voice signal 431 to the TISV 375 (and the speaker feature extraction model 370).

FIG. 4D illustrates an example of the VF 380 included in the electronic device 101 (or the memory 340) of FIG. 3. Referring to FIG. 4D, an example 404 of a method in which the VF 380 extracts a voice portion uttered by a specific user from a voice signal 441 based on the received voice signal 441 is illustrated. For convenience of explanation, it is assumed that the voice signal 441 includes voice portions uttered by a plurality of users. However, the present disclosure is not limited thereto.

Referring to the example 404, the electronic device 101 may provide (or feed, input) a voice signal 441 received through the input interface 320 to the VF 380. For example, the VF 380 may perform preprocessing 443 on the provided voice signal 441. For example, the content of the preprocessing 411 of FIG. 4A may be substantially equally applied to the specific content of the preprocessing 443 of FIG. 4D. However, the present disclosure is not limited thereto. For example, the preprocessing 443 may include processes other than preprocessing 411. In accordance with the preprocessing 443, the voice signal 441 may be converted into a frequency domain according to fast Fourier transform (FFT), and magnitudes in the frequency domain may be extracted.

For example, the VF 380 may provide, to a voice enhancement model 445, the voice signal 441 on which the preprocessing 443 is performed (hereinafter, the preprocessed voice signal 441). For example, the voice enhancement model 445 may be implemented with a neural network (NN). For example, the voice enhancement model 445 may be used to maintain frequency energy (or magnitude in the frequency domain) corresponding to a voice portion of a user indicated by the reference identification information 445-1 in the preprocessed voice signal 441 using the reference identification information 445-1 and reduce energy corresponding to a voice portion of remaining users. For example, the reference identification information 445-1 may be identification information in the identification information set 390 stored in the memory 340. For example, the reference identification information 445-1 may indicate a designated user with respect to the virtual assistant (e.g., a registered user or a temporarily allowed user).

For example, the VF 380 may perform inverse-FFT (IFFT) 447 on the voice signal 441 outputted from the voice enhancement model 445. For example, the VF 380 may convert (or restore) the voice signal 441 converted to a frequency domain back to a voice signal (or time domain) by performing the IFFT 447. Accordingly, the VF 380 may output a filtered voice signal 449. Compared to the voice signal 441, the filtered voice signal 449 may be a voice signal in which a voice portion of a user indicated by the reference identification information 445-1 is maintained and a voice portion of remaining users is reduced. In other words, in the voice signal 441, the voice portion of the user indicated by the reference identification information 445-1 may be prominently left according to filtering based on the VF 380.

FIG. 4E illustrates an example of a VAD 385 included in the electronic device 101 (or the memory 340) of FIG. 3. Referring to FIG. 4E, an example 405 of a method in which the VAD 385 detects a voice portion from among a voice signal 451 based on the received voice signal 451 is illustrated. For convenience of explanation, it is assumed that the voice signal 451 includes voice portions uttered by a plurality of users. However, the present disclosure is not limited thereto.

Referring to the example 405, the electronic device 101 may provide (or feed, input) a voice signal 451 received through the input interface 320 to the VAD 385. For example, the VAD 385 may perform preprocessing 453 on the provided voice signal 451. For example, the contents of the preprocessing 411 of FIG. 4A may be substantially equally applied to the specific contents of the preprocessing 453 of FIG. 4E. However, the present disclosure is not limited thereto. For example, the preprocessing (453) may include processes other than the preprocessing 411.

For example, the VAD 385 may provide, to a VAD model 455, the voice signal 451 on which the preprocessing 453 is performed (hereinafter, the preprocessed voice signal 451). For example, the VAD model 455 may be implemented with statistical signal processing or neural network (NN). For example, the VAD model 455 may be used to detect a voice portion in the preprocessed voice signal 451. For example, the detected voice portion may indicate a voice uttered by a person, without distinguishing between users. For example, the VAD model 455 may detect whether a voice portion is present at a specific time interval (e.g., 20 milliseconds (ms)) (or frame) with respect to the preprocessed voice signal 451.

For example, the VAD 385 may perform post-processing 457 on the voice signal 451 outputted from the VAD model 455. For example, the post-processing 457 may include compensating for distortion in accordance with the pre-processing 453 or outputting a value indicating a voice portion detected by the VAD model 455. However, the present disclosure is not limited thereto. For example, the VAD 385 may skip the post-processing 457. Accordingly, the VAD 385 may generate (or output) a detected voice signal 459 without performing the post-processing 457.

For example, the VAD 385 may generate (or output) the detected voice signal 459 based on the voice signal 451. For example, the detected voice signal 459 may indicate ‘1’ for a specific time interval when a voice portion is present within the specific time interval, and may indicate ‘0’ for the specific time interval when a voice portion is not present within the specific time interval. In the example 405, the detected voice signal 459 may indicate ‘000111111111000’. For example, the detected voice signal 459 may include a voice duration and a non-voice duration within the voice signal 451. For example, the voice duration may be ‘111111111’. For example, the non-voice duration may be ‘000’ and ‘000’. In other words, the VAD 385 may detect the voice duration of the voice portion.

According to an embodiment, the VAD 385 may be used not only to detect a voice portion within the voice signal 451, but also to identify a position (or a timing) at which the voice portion ends. For example, identifying a position at which the voice portion ends may be referred to as end-point detection (EPD). In the example 405, the position (or timing) at which the voice portion ends within the voice signal 451 may be a position (or timing) indicated by the last 1 among ‘000111111111000’ of the detected voice signal 459 (or a position (or timing) at which the last 1 is changed to a continuous 0). The above example illustrates identifying a position at which the voice portion ends, but the present disclosure is not limited thereto. For example, within the voice signal 451, a position where the voice portion starts may also be identified.

FIG. 4F illustrates an example of the VAD 385 included in the electronic device 101 (or the memory 340) of FIG. 3. Referring to FIG. 4F, an example 406 of a method in which the VAD 385 detects a voice portion uttered by a specific user from among a voice signal 461 based on the received voice signal 461 is illustrated. In other words, unlike the VAD 385 of the example 405, the VAD 385 of the example 406 may be used to detect a voice portion of a specific user, rather than all voice portions within the voice signal. Accordingly, the VAD 385 of the example 406 may be referred to as a personal VAD. For convenience of explanation, it is assumed that the voice signal 461 includes voice portions uttered by a plurality of users. However, the present disclosure is not limited thereto.

Referring to the example 406, the electronic device 101 may provide (or feed, input) a voice signal 461 received through the input interface 320 to the VAD 385. For example, the VAD 385 may perform preprocessing 463 on the provided voice signal 461. For example, the content of the preprocessing 411 of FIG. 4A may be substantially equally applied to the specific content of the preprocessing 463 of FIG. 4F. However, the present disclosure is not limited thereto. For example, the preprocessing 463 may include processes other than preprocessing 411.

For example, the VAD 385 may provide, to a personal VAD model 465, a voice signal 461 on which preprocessing 463 is performed (hereinafter, preprocessed voice signal 461). For example, the personal VAD model 465 may be implemented with a neural network (NN). For example, the personal VAD model 465 may be used to detect a voice portion of a user indicated by the reference identification information 465-1 in the preprocessed voice signal 451, by using the reference identification information 465-1. At this time, the user indicated by the reference identification information 465-1 may be referred to as a target user (or target speaker). For example, the detected voice portion may indicate a voice uttered by the user indicated by the reference identification information 465-1. For example, the personal VAD model 465 may detect whether a voice portion is present at a specific time interval (e.g., 20 ms) (or frame) with respect to the preprocessed voice signal 461. For example, the reference identification information 465-1 may be identification information within the identification information set 390 stored in the memory 340. For example, the reference identification information 465-1 may indicate a user designated for the virtual assistant (e.g., a registered user or a temporarily allowed user).

For example, the VAD 385 may perform post-processing 467 on the voice signal 461 outputted from the personal VAD model 465. For example, the post-processing 467 may include compensating for distortion in accordance with the pre-processing 463 or outputting a value indicating a voice portion detected by the personal VAD model 465.

For example, the VAD 385 may generate (or output) a detected voice signal 469 based on the voice signal 461. For example, the detected voice signal 469 may indicate ‘1’ for a specific time interval when a voice portion is present within the specific time interval, and may indicate ‘0’ for the specific time interval when a voice portion is not present within the specific time interval. In the example 406, the detected voice signal 469 may indicate ‘000000111111000’. For example, the detected voice signal 469 may include a voice duration and a non-voice duration within the voice signal 461. For example, the voice duration may be ‘111111’. For example, the non-voice duration may be ‘000000’ and ‘000’. In other words, the VAD 385 may detect the voice duration of the voice portion.

When the voice signal 451 of the example 405 and the voice signal 461 of the example 406 are the same, compared to the detected voice signal 459 of the example 405, the detected voice signal 469 of the example 406 may indicate ‘111111’, which is the voice portion of the user indicated by the reference identification information 465-1.

According to an embodiment, the VAD 385 may be used not only to detect a voice portion within the voice signal 461, but also to identify a position (or timing) at which the voice portion ends. For example, identifying a position at which the voice portion ends may be referred to as end-point detection (EPD). For specific details related thereto, FIG. 4E may be referred to.

Referring to the above description, since the VAD 385 of FIG. 4F may detect a voice portion uttered by a specific user within a voice signal, it may be used to replace or complement the TISV 375 (or TDSV). In other words, examples in which the TISV 375, exemplified below is used may be substantially equally applied to the VAD 385 instead of the TISV 375.

As a non-limiting example, the reference identification information 465-1 used in the VAD 385, the reference identification information 445-1 used in the VF 380, and the reference identification information 435-1 used in the TISV 375 of the example 406 may be different from each other. For example, the reference identification information 465-1 indicating the specific user, the reference identification information 445-1 indicating the specific user, and the reference identification information 435-1 indicating the specific user may be different from each other. In other words, in models (e.g., the TISV 375, the VF 380, and the VAD 385 of the example 406) available for recognizing a user, reference identification information indicating the same user may be different from each other.

At least one of the components, elements, modules or units represented by a block as illustrated in FIGS. 4A-4F may be embodied as various combinations of hardware, software and/or firmware structures that execute respective functions described above, according to an exemplary embodiment. For example, at least one of these components, elements, modules or units may use a direct circuit structure, such as a memory, processing, logic, a look-up table, etc. that may execute the respective functions through controls of one or more microprocessors or other control apparatuses. Also, at least one of these components, elements, modules or units may be specifically embodied by a module, a program, or a part of code, which contains one or more executable instructions for performing specified logic functions, and executed by one or more microprocessors or other control apparatuses. Also, at least one of these components, elements, modules or units may further include a processor such as a central processing unit (CPU) that performs the respective functions, a microprocessor, or the like. Two or more of these components, elements, modules or units may be combined into one single component, element, module or unit which performs all operations or functions of the combined two or more components, elements, modules or units. Also, at least part of functions of at least one of these components, elements, modules or units may be performed by another of these components, elements, modules or units. Further, although a bus is not illustrated in the above block diagrams, communication between the components, elements, modules or units may be performed through the bus. Functional aspects of the above exemplary embodiments may be implemented in algorithms that execute on one or more processors. Furthermore, the components, elements, modules or units represented by a block or processing steps may employ any number of related art techniques for electronics configuration, signal processing and/or control, data processing and the like.

FIG. 5 illustrates an example of an operation flow in which a model for a virtual assistant is trained with respect to a specific user.

At least a portion of the method in FIG. 5 may be performed by the electronic device 101 of FIG. 3. For example, the at least a portion of the method may be configured to be performed (or controlled) by at least one processor 310 of the electronic device 101. In the following embodiment, each operation may be performed sequentially, but is not necessarily performed sequentially. For example, the sequence of each operation may be changed, and at least two operations may be performed in parallel.

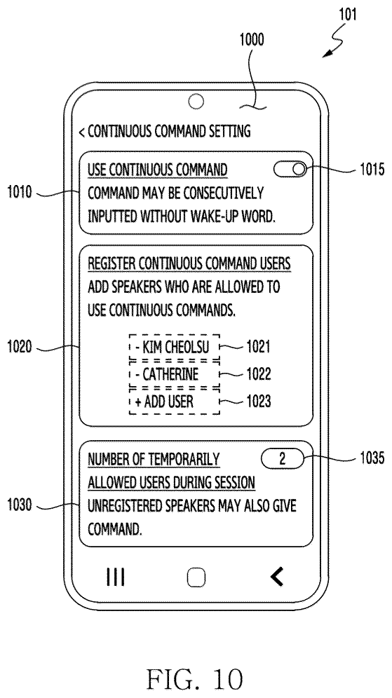

According to an embodiment, the electronic device 101 may execute a virtual assistant application 350. As a non-limiting example, the electronic device 101 may execute the virtual assistant application 350 in the foreground. A screen of the virtual assistant application 350 executed in the foreground may be displayed through a display of the electronic device 101. For example, the screen may include a menu for setting the virtual assistant application 350. For example, an example of the menu for setting the virtual assistant application 350 may be illustrated in FIG. 10.

Referring to FIG. 5, in operation 500, according to an embodiment, the electronic device 101 may display learning text. For example, the electronic device 101 may display the learning text within the screen displayed through the display of the electronic device 101. For example, the learning text may be text used to register a user with a virtual assistant of the virtual assistant application 350 (or to train models with respect to the user). The learning text may be referred to as utter text. As a non-limiting example, the learning text may include a wake-up word, a command word, a specific sentence, or a specific word.

In operation 500, a case where the learning text is displayed is illustrated, but the present disclosure is not limited thereto. For example, the electronic device 101 may output TTS synthesized sound corresponding to the learning text as audio information via the speaker 330.

In operation 505, according to an embodiment, the electronic device 101 may receive a voice signal. For example, the electronic device 101 may wait to receive a voice signal by activating the input interface 320. For example, activating the input interface 320 may indicate switching to a state capable of receiving a sound signal (or voice signal) from outside the electronic device 101 through the input interface 320. The above example illustrates activating the input interface 320 to receive the voice signal, but the present disclosure is not limited thereto. For example, the electronic device 101 may activate the input interface 320 regardless of displaying the learning text. For example, the electronic device 101 may receive the voice signal through the activated input interface 320.

In operation 510, according to an embodiment, the electronic device 101 may determine whether the voice signal corresponds to the training text, based on utterance verification. For example, the electronic device 101 may perform the utterance verification. For example, the electronic device 101 may determine (or verify, identify, decide) whether the voice signal corresponds to the training text displayed in operation 500, by converting the voice signal received through the input interface 320 into text. For example, converting the voice signal into text may be performed using the ASR module 360 of the electronic device 101.

In operation 510, the electronic device 101 may perform operation 515 when the voice signal corresponds to the learning text in accordance with the utterance verification. When the voice signal corresponds to the learning text, the utterance verification may be referred to as successful. In operation 515, the electronic device 101 may perform operation 500 again when the voice signal does not correspond to the learning text in accordance with the utterance verification. When the voice signal does not correspond to the learning text, the utterance verification may be referred to as failed.

In operation 515, according to an embodiment, the electronic device 101 may determine whether the utterance verification has been performed a reference number of times. For example, the electronic device 101 may determine whether the number of successful utterance verifications has been performed a reference number of times. In operation 515, the electronic device 101 may perform operation 500 again when the utterance verification has not been performed a reference number of times. In operation 515, the electronic device 101 may perform operation 520 when the utterance verification has been performed the reference number of times.

When the operation 500 is performed again, the learning text may be changed to other learning text. However, the present disclosure is not limited thereto. For example, the learning text may be maintained.

In operation 520, according to an embodiment, the electronic device 101 may perform model training. For example, the electronic device 101 may perform model training based on the voice signal received in operation 505. The model in which the training is performed may include the speaker feature extraction model 370 of FIGS. 4A and 4B, the TISV 375 (or TDSV) of FIG. 4C, the VF 380 of FIG. 4D, or the VAD 385 of FIG. 4F. As a non-limiting example, the electronic device 101 may perform model training based on the voice signal including a wake-up word. Accordingly, when a voice signal including the wake-up word is received, the electronic device 101 may recognize a user who uttered the wake-up word, by using a trained model.

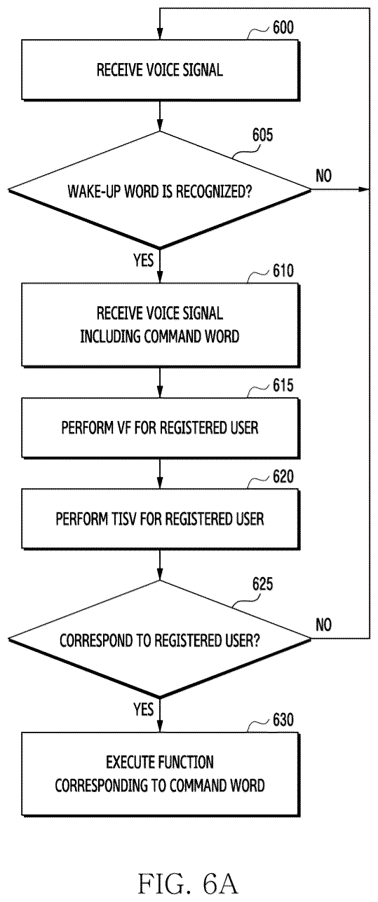

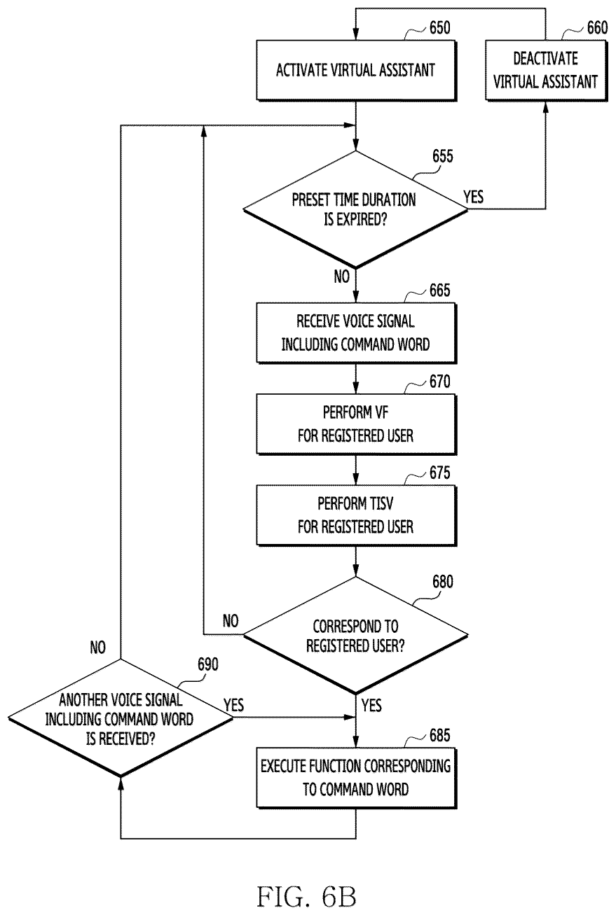

Based on the model trained according to the method of FIG. 5, the electronic device 101 may generate identification information indicating a specific user who uttered the voice signal, verify a specific user who uttered the voice signal, filter a voice portion of a specific user within the voice signal, or detect a voice portion uttered by a specific user within the voice signal, as described later in FIGS. 6A to 8.

FIG. 6A illustrates an example of an operation flow for a method of executing, based on a voice signal uttered by a user registered with respect to a virtual assistant, a function corresponding to a command word of the voice signal.

At least a portion of the method of FIG. 6A may be performed by the electronic device 101 of FIG. 3. For example, at least a portion of the method may be configured to be performed (or controlled) by at least one processor 310 of the electronic device 101. In the following embodiment, each operation may be performed sequentially, but is not necessarily performed sequentially. For example, the sequence of each operation may be changed, and at least two operations may be performed in parallel.

According to an embodiment, before performing operation 600, the electronic device 101 may register (or store) a user with respect to a virtual assistant. For example, the user may be referred to as a registered user. In addition, the electronic device 101 may execute the virtual assistant application 350 in the background.

In operation 600, according to an embodiment, the electronic device 101 may receive a voice signal. For example, the electronic device 101 may receive the voice signal through the activated input interface 320.

In operation 605, according to an embodiment, the electronic device 101 may determine whether a wake-up word is recognized. For example, the electronic device 101 may recognize a wake-up word within the received voice signal, by converting the received voice signal into text.

In operation 605, when a wake-up word is recognized within the received voice signal, the electronic device 101 may perform operation 610. In operation 605, when a wake-up word is not recognized in the received voice signal, the electronic device 101 may perform operation 600 again.

For example, the electronic device 101 may activate the virtual assistant when a wake-up word is recognized in the received voice signal. In FIG. 6A, it is illustrated that the virtual assistant is activated according to whether a wake-up word is recognized, but the present disclosure is not limited thereto. For example, the electronic device 101 may activate the virtual assistant in response to an input to the electronic device 101 (or user input). For example, the input may include an input to a physical button of the electronic device 101 or a visual object (or icon) displayed through a display of the electronic device 101.

As a non-limiting example, the electronic device 101 may identify a user who uttered the wake-up word based on the recognized wake-up word. For example, the electronic device 101 may recognize that the user who uttered the wake-up word is the registered user.

In operation 610, according to an embodiment, the electronic device 101 may receive a voice signal including a command word. For example, the electronic device 101 may receive the voice signal including the command word through the input interface 320. In FIG. 6A, for convenience of explanation, it is illustrated that the voice signal received in operation 600 includes a wake-up word and the voice signal received in operation 610 includes a command word, but the present disclosure is not limited thereto. For example, one voice signal may include both a wake-up word and a command word.

In operation 615, according to an embodiment, the electronic device 101 may perform a VF for a registered user. For example, the electronic device 101 may output a filtered voice signal through the VF 380 with respect to the voice signal including the command word received in operation 610. For example, the electronic device 101 may provide the voice signal including the command word to the VF 380. For example, the electronic device 101 may filter a voice portion uttered by the registered user in the voice signal including the command word, through the VF 380 using reference identification information indicating the registered user. For example, the registered user may correspond to a user recognized in operation 605 of recognizing a wake-up word. For example, the electronic device 101 may perform VF (and/or TISV of operation 620 to be described later), by using identification information corresponding to the user who uttered the wake-up word, while recognizing the wake-up word.

In an example, when the voice signal including the command word is uttered by the registered user, the filtered voice signal may have a relatively high frequency energy in the voice portion uttered by the registered user. On the other hand, when the voice signal including the command word is uttered by another user different from the registered user, the filtered voice signal may have a relatively low frequency energy throughout the voice signal. This may be because the frequency energy of users other than the registered users is reduced by the VF 380.

In operation 620, according to an embodiment, the electronic device 101 may perform a TISV for a registered user. For example, the electronic device 101 may output a result indicating whether a user who uttered the voice signal including the command word corresponds to the registered user, through the TISV 375, with respect to the voice signal filtered in operation 615. For example, the electronic device 101 may provide the filtered voice signal to the TISV 375. For example, the electronic device 101 may generate a speaker feature vector (or identification information) through TISV 375 (or speaker feature extraction model 370), based on the filtered voice signal. For example, the electronic device 101 may identify a similarity value between the speaker feature vector (or identification information) and reference identification information indicating the registered user. For example, the electronic device 101 may output a result (e.g., the first value 439-1 or the second value 439-2 of FIG. 4C) indicating whether a user who uttered the voice signal including the command word is the registered user, by performing a comparison between the similarity value and the reference value through the TISV 375.

In operation 625, according to an embodiment, the electronic device 101 may determine whether to correspond to the registered user. For example, the electronic device 101 may determine whether a user who uttered a voice signal including the command word received in operation 610 corresponds to is corresponding to (or is identical to, or coincides with) the registered user.

In operation 625, when the user who uttered the voice signal including the command word received in operation 610 corresponds to the registered user, operation 630 may be performed. In operation 625, when the user who uttered the voice signal including the command word received in operation 610 does not correspond to the registered user, the operation 600 may be performed again.

In operation 630, according to an embodiment, the electronic device 101 may execute a function corresponding to a command word. For example, the electronic device 101 may execute the function corresponding to the received command word, based on the activated virtual assistant.

FIG. 6A describes that TISV is performed in operation 620 for a result (e.g., filtered voice signal) outputted after performing operation 615, but the present disclosure is not limited thereto. For example, the electronic device 101 may respectively perform VF and TISV, with respect to the voice signal received in operation 610. This may be to compensate for distortions that may be caused as VF is performed. According to an embodiment, for example, the electronic device 101 may omit (or not perform, skip, refrain from performing, and bypass) operation 615, and perform operation 620. According to an embodiment, for example, the electronic device 101 may omit (or not perform, skip, refrain from performing, and bypass) at least a portion of operation 620. For example, the at least a portion of operation 620 may include identifying a similarity value, performing a comparison between the similarity value and a reference value, and outputting a result indicating whether the user is a registered user. In other words, in operation 620, the electronic device 101 may perform only generating identification information based on the voice signal received in operation 610.

In addition, for example, the electronic device 101 may use the personal VAD 385 of FIG. 4F. For example, instead of determining whether a registered user corresponds to a user who uttered a voice signal received through TISV 375 in operation 620, the electronic device 101 may determine whether the registered user corresponds to a user who uttered a voice signal received through the personal VAD 385. According to an embodiment, the electronic device 101 may detect a voice portion of the registered user within a voice signal including a command word through the personal VAD 385 before performing operation 620, and may provide the detected voice signal to the TISV 375. In this case, reference identification information used as a reference for the personal VAD 385 may indicate the registered user. As the personal VAD 385 is further used, a voice signal excluding a portion uttered by another user and a noise portion is used in the TISV 375, so more accurate user verification may be performed.

FIG. 6A illustrates an operation of receiving a voice signal including one command word and performing a function corresponding to the command word, but the present disclosure is not limited thereto. For example, the electronic device 101 may execute functions corresponding to consecutive voice signals in accordance with executing the continuous command function of the activated virtual assistant. Hereinafter, for specific content related thereto, FIG. 6B may be referred to.

FIG. 6B illustrates an example of an operation flow for a method of executing, based on a voice signal uttered by a user registered with respect to a virtual assistant, a function corresponding to a command word of the voice signal, in a continuous command function of the virtual assistant.

At least a portion of the method of FIG. 6B may be performed by the electronic device 101 of FIG. 3. For example, at least a portion of the method may be configured to be performed (or controlled) by at least one processor 310 of the electronic device 101. In an embodiment, each operation may be performed sequentially, but is not necessarily required to be performed sequentially. For example, the sequence of each operation may be changed, and at least two operations may be performed in parallel.

According to an embodiment, before performing operation 650, the electronic device 101 may register (or store) a user with respect to a virtual assistant. For example, the user may be referred to as a registered user. In addition, the electronic device 101 may execute the virtual assistant application 350 in the background.

In operation 650, according to an embodiment, the electronic device 101 may activate a virtual assistant. For example, the electronic device 101 may receive a voice signal including a wake-up word and activate the virtual assistant by recognizing a wake-up word within the received voice signal. According to an embodiment, the electronic device 101 may also activate the virtual assistant in response to an input to the electronic device 101.

According to an embodiment, the electronic device 101 may execute a continuous command function of the virtual assistant. For example, the electronic device 101 may execute the continuous command function by receiving a voice signal including a command word for executing the continuous command function of the virtual assistant. For example, the electronic device 101 may execute the continuous command function in response to an input for executing the continuous command function of the virtual assistant. As a non-limiting example, the input for executing the continuous command function may include a touch input, a double touch input, a press input (e.g., long press), or an input to an external electronic device (e.g., true wired stereo (TWS), smart watch, or smart ring) connected to the electronic device 101. For example, the external electronic device may transmit, to the electronic device 101, a signal informing that an input to the external electronic device is received. The electronic device 101 may execute the continuous command function in accordance with reception of the signal.

In operation 655, according to an embodiment, the electronic device 101 may determine whether a preset time duration is expired. For example, in operation 650, the electronic device 101 may start a timer for the preset time duration from a timing when the virtual assistant is activated. As a non-limiting example, the preset time duration may be 7 seconds. However, the present disclosure is not limited thereto. For example, the electronic device 101 may adjust a length of the preset time duration in a menu for setting of the virtual assistant application 350. According to an embodiment, when the user uses the electronic device 101 or is looking at the electronic device 101, the electronic device 101 may increase the length of the preset time duration or initialize the timer. For example, the electronic device 101 may identify whether a command word (or voice signal including a command word) is received, by activating the input interface 320 during the preset time duration. For example, during the preset time duration, the electronic device 101 may be in a standby state to receive a command word (or voice signal including a command word) through the virtual assistant. The preset time duration may be referred to as a waiting time.

In operation 655, when the preset time duration is expired, the electronic device 101 may perform operation 660. In operation 655, when the preset time duration is not expired, the electronic device 101 may perform operation 665.

In operation 660, according to an embodiment, the electronic device 101 may deactivate the virtual assistant. For example, when the preset time duration is expired, the electronic device 101 may deactivate the activated virtual assistant. For example, the preset time duration may be used as a trigger for the activated virtual assistant to be deactivated again.

In operation 665, according to an embodiment, the electronic device 101 may receive a voice signal including a command word. For example, the electronic device 101 may receive a voice signal including the command word through the input interface 320, before the preset time duration is expired.

In operation 670, according to an embodiment, the electronic device 101 may perform a VF for a registered user. For example, the electronic device 101 may output a filtered voice signal, through the VF 380, with respect to the voice signal including the command word received in operation 665. For example, the electronic device 101 may provide, to the VF 380, the voice signal including the command word. For example, the electronic device 101 may filter a voice portion uttered by the registered user in the voice signal including the command word, through the VF 380 using reference identification information indicating the registered user.

In operation 675, according to an embodiment, the electronic device 101 may perform a TISV for a registered user. For example, the electronic device 101 may output a result indicating whether a user who uttered the voice signal including the command word corresponds to the registered user, through the TISV 375, with respect to the voice signal filtered in operation 670. For example, the electronic device 101 may provide the filtered voice signal to the TISV 375. For example, the electronic device 101 may generate a speaker feature vector (or identification information) through the TISV 375 (or speaker feature extraction model 370), based on the filtered voice signal. For example, the electronic device 101 may identify a similarity value between the speaker feature vector (or identification information) and reference identification information indicating the registered user. For example, the electronic device 101 may output a result (e.g., the first value 439-1 or the second value 439-2 of FIG. 4C) indicating whether a user who uttered the voice signal including the command word is the registered user, by performing the comparison between the similarity value and the reference value through the TISV 375.

In operation 680, according to an embodiment, the electronic device 101 may determine whether to correspond to the registered user. For example, the electronic device 101 may determine whether the user who uttered a voice signal including the command word received in operation 665 is corresponding to (or is identical to, or coincides with) the registered user.

In operation 680, when a user who uttered a voice signal including the command word received in operation 665 corresponds to the registered user, operation 685 may be performed. According to an embodiment, in operation 680, when a user who uttered a voice signal including the command word received in operation 665 does not correspond to the registered user, the operation 655 may be performed again. When operation 655 is performed again, the electronic device 101 may start (or initialize) a timer for the preset time duration in accordance with determining that a user who uttered the received voice signal including the command word does not correspond to the registered user.

In operation 685, according to an embodiment, the electronic device 101 may execute a function corresponding to the command word. For example, the electronic device 101 may execute the function corresponding to the received command word, based on the activated virtual assistant.

In operation 690, according to an embodiment, the electronic device 101 may determine whether another voice signal including a command word is received. For example, the electronic device 101 may determine whether the other voice signal including a command word is received while executing the function according to operation 685. For example, the function may include playing of TTS composite sound. In other words, the electronic device 101 may determine whether the other voice signal including a command word is further received, while the function is being executed.

In operation 690, when the electronic device 101 further receives the other voice signal including a command word while executing the function, the electronic device 101 may perform operation 685 again. In a case that the function performed in operation 685 performed before operation 690 is performed is playing of TTS composite sound, when the electronic device 101 further receives the other voice signal while executing the function, the electronic device 101 may delete a portion corresponding to playing of the TTS composite sound in the other voice signal. For example, the electronic device 101 may delete a portion corresponding to playing of the TTS composite sound within the other voice signal, through an adaptive echo canceller (AEC). In an example, when the electronic device 101 further receives the other voice signal while playing the TTS composite sound, the electronic device 101 may cease playing the TTS composite sound or reduce a volume for playing the TTS composite sound.

In operation 690, when the electronic device 101 does not receive the other voice signal including a command word while executing the function, the electronic device 101 may perform operation 655 again. For example, as the electronic device 101 performs operation 655 again, the electronic device 101 may start a timer for the preset time duration.

Thereafter, in operation 655 performed again, the electronic device 101 may determine whether a voice signal including a command word is received within the preset time duration, and perform operations 665 to 690 again when received.

In the example of FIG. 6B, it is illustrated that whether another voice signal including a command word is further received in operation 690 while executing a function corresponding to the command word in operation 685 is determined, but the present disclosure is not limited thereto. For example, the electronic device 101 may determine whether another voice signal including a command word is further received in operation 690, between operation 685 and operation 665. Accordingly, the electronic device 101 may further receive another voice signal through the input interface 320 while processing (e.g., ASR, NLU, VR, TISV) the received voice signal. As a non-limiting example, the electronic device 101 may simultaneously process a command word of the voice signal and a command word of the other voice signal. In an example, when the electronic device 101 uses a large language model (LLM) in the virtual assistant application 350, the voice signal and the other voice signal may be simultaneously provided as a prompt for the LLM. As a non-limiting example, the electronic device 101 may process a command word of the voice signal and then process a command word of the other voice signal.

The LLM refers to an artificial neural network-based language model that has learned a large amount of text data through pre-learning. The LLM may include relatively more parameters (e.g., more than 10 billion) than general language models. The LLM is one of machine learning models used in a field of natural language processing, and may be used to learn a large amount of text data to perform prediction on new text data. The LLM may be used for tasks such as natural language understanding, sentence generation, translation, grammar error correction, and summarization.

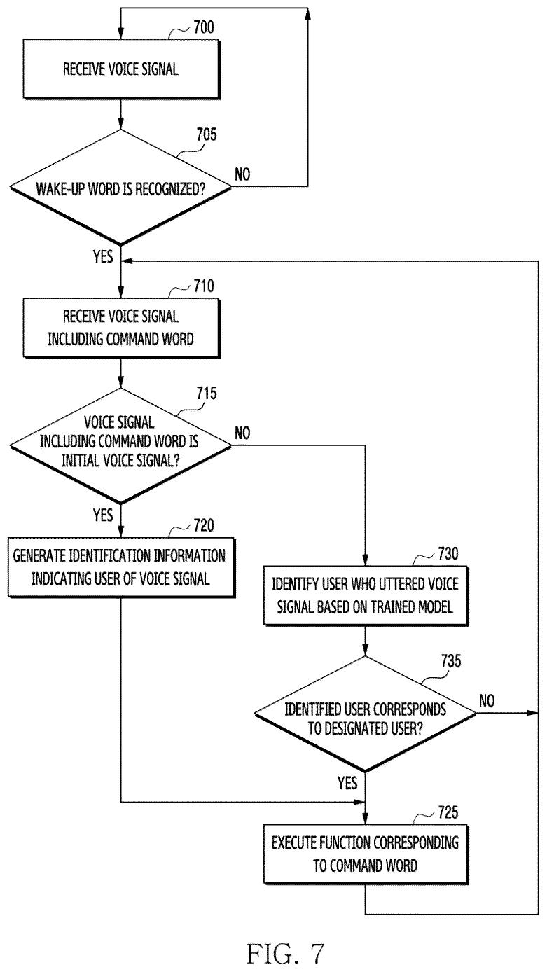

FIG. 6A illustrates an example of receiving a voice signal including a command word through the virtual assistant when the continuous command function is not executed, and performing VF and/or TISV using reference identification information indicating a registered user with respect to the received voice signal. In addition, FIG. 6B illustrates an example of receiving a voice signal including a command word through the virtual assistant when the continuous command function is executed, and performing VF and/or TISV using reference identification information indicating a registered user with respect to the received voice signal. Hereinafter, FIG. 7 describes an example of a method in which the electronic device 101 executes functions corresponding to command words based on temporary allow, while the continuous command function of the virtual assistant is being executed.

FIG. 7 illustrates an example of an operation flow for a method of executing, based on a voice signal uttered by a temporary allow user, a function corresponding to a command word of the voice signal, in a continuous command function of a virtual assistant.

At least a portion of the method of FIG. 7 may be performed by the electronic device 101 of FIG. 3. For example, at least a portion of the method may be configured to be performed (or controlled) by at least one processor 310 of the electronic device 101. In the following embodiment, each operation may be performed sequentially, but is not necessarily performed sequentially. For example, the sequence of each operation may be changed, and at least two operations may be performed in parallel.

According to an embodiment, before performing operation 700, the electronic device 101 may register (or store) a user with respect to a virtual assistant. For example, the user may be referred to as a registered user. In addition, the electronic device 101 may execute the virtual assistant application 350 in the background.

In operation 700, according to an embodiment, the electronic device 101 may receive a voice signal. For example, the electronic device 101 may receive the voice signal through the activated input interface 320.

In operation 705, according to an embodiment, the electronic device 101 may determine whether a wake-up word is recognized. For example, the electronic device 101 may recognize a wake-up word within a received voice signal by converting the received voice signal into text.

In operation 705, when a wake-up word is recognized within the received voice signal, the electronic device 101 may perform operation 710. In operation 705, when a wake-up word is not recognized within the received voice signal, the electronic device 101 may perform operation 700 again.

For example, the electronic device 101 may activate the virtual assistant when a wake-up word is recognized within the received voice signal. FIG. 7 illustrates that the virtual assistant is activated according to whether a wake-up word is recognized, but the present disclosure is not limited thereto. For example, the electronic device 101 may activate the virtual assistant in response to an input (or user input) to the electronic device 101. For example, the input may include an input to a physical button of the electronic device 101 or a visual object (or icon) displayed through a display of the electronic device 101.

According to an embodiment, the electronic device 101 may execute a continuous command function of the virtual assistant. For example, the electronic device 101 may execute the continuous command function, by receiving a voice signal including a command word for executing the continuous command function of the virtual assistant. For example, the electronic device 101 may execute the continuous command function in response to an input for executing the continuous command function of the virtual assistant. As a non-limiting example, the input for executing the continuous command function may include a touch input, a double touch input, a press input (e.g., long press), or an input to an external electronic device (e.g., true wired stereo (TWS), smart watch, or smart ring) connected to the electronic device 101. For example, the external electronic device may transmit, to the electronic device 101, a signal informing that an input to the external electronic device is received. The electronic device 101 may execute the continuous command function in accordance with reception of the signal.

In operation 710, according to an embodiment, the electronic device 101 may receive a voice signal including a command word. For example, the electronic device 101 may receive the voice signal including the command word through the input interface 320. In FIG. 7, for convenience of explanation, it is illustrated that the voice signal received in operation 700 includes a wake-up word and the voice signal received in operation 710 includes a command word, but the present disclosure is not limited thereto. For example, one voice signal may include both a wake-up word and a command word.

In operation 715, according to an embodiment, the electronic device 101 may determine whether a voice signal including a command word is an initial voice signal. For example, the electronic device 101 may determine whether the voice signal including the received command word is the initial voice signal, after the virtual assistant is activated. The initial voice signal may be a voice signal including a command word initially received from a timing when the electronic device 101 activates the virtual assistant.

In operation 715, when a voice signal including the received command word is the initial voice signal, the electronic device 101 may perform operation 720. According to an embodiment, in operation 715, when a voice signal including the received command word is not the initial voice signal, the electronic device 101 may perform operation 730.

Hereinafter, for convenience of explanation, it is assumed that a voice signal received in initially performed operation 710 is a first voice signal.

In operation 720, according to an embodiment, the electronic device 101 may generate identification information indicating a user of a voice signal. For example, the electronic device 101 may generate first identification information indicating a first user who uttered the first voice signal including the command word. For example, the first identification information may be generated through the speaker feature extraction model 370 of FIG. 4A. As a non-limiting example, the first identification information may be generated based on the first voice signal. In an example, the first identification information may include a speaker feature vector (or a vector value) generated based on the first voice signal. For example, the first identification information may be used to temporarily allow the first user who uttered the first voice signal, which is a voice signal initially received after the virtual assistant is activated. In other words, the first user may be a temporary allow user. As a non-limiting example, the electronic device 101 may store (or cache, or temporarily store) the first identification information in the memory 340.

In operation 725, according to an embodiment, the electronic device 101 may execute a function corresponding to a command word. For example, the electronic device 101 may execute a function corresponding to the command word of the first voice signal. After performing operation 725, the electronic device 101 may perform operation 710 again. The example of FIG. 7 illustrates performing operation 725 and then performing operation 710 again, but the present disclosure is not limited thereto. As described above in FIG. 6B, while or before performing operation 725, the electronic device 101 may perform operation 710.

In operation 710 performed again, the electronic device 101 may receive a voice signal including a command word. Hereinafter, for convenience of explanation, it is assumed that a voice signal including a command word, which is received in operation 710 performed again, is a second voice signal.

In operation 715, the electronic device 101 may determine whether a voice signal including a command word is an initial voice signal. For example, the electronic device 101 may determine whether the second voice signal is the initial voice signal. Since the second voice signal is not the initial voice signal, the electronic device 101 may perform operation 730.

In operation 730, according to an embodiment, the electronic device 101 may identify a user who uttered a voice signal based on a trained model. For example, the trained model may include at least one of the TISV 375, the VF 380, or the personal VAD 385. For example, the electronic device 101 may identify the second user who uttered the second voice signal through the trained model using the first identification information as a reference. Identifying the second user may include determining whether the second user who uttered the second voice signal is the same user as the first user or a different user.

As a non-limiting example, the electronic device 101 may provide the second voice signal to the VF 380 using the first identification information as reference identification information. For example, the VF 380 may maintain a portion uttered by the first user indicated by the first identification information within the second voice signal, and suppress (or reduce) a portion uttered by another user.

As a non-limiting example, the electronic device 101 may provide the second voice signal to the TISV 375 using the first identification information as reference identification information. As a non-limiting example, the second voice signal provided to the TISV 375 may be a second voice signal filtered through the VF 380 as described above. As a non-limiting example, the second voice signal provided to the TISV 375 may be a second voice signal received through the input interface 320 (or a second voice signal that is not filtered through the VF 380). For example, the TISV 375 may generate second identification information indicating the second user who uttered the second voice signal, based on the second voice signal. For example, the TISV 375 may identify a similarity value between the second identification information indicating the second user who uttered the second voice signal and the first identification information. For example, the TISV 375 may perform a comparison between the similarity value and a reference value. For example, the TISV 375 may output a result indicating whether the second user who uttered the second voice signal corresponds to the first user who uttered the first voice signal. For example, the result may include one of a first value (e.g., the first value 439-1 in FIG. 4C) indicating that the first user corresponds to the second user and a second value (e.g., the second value 439-2 in FIG. 4C) indicating that the first user does not correspond to the second user.

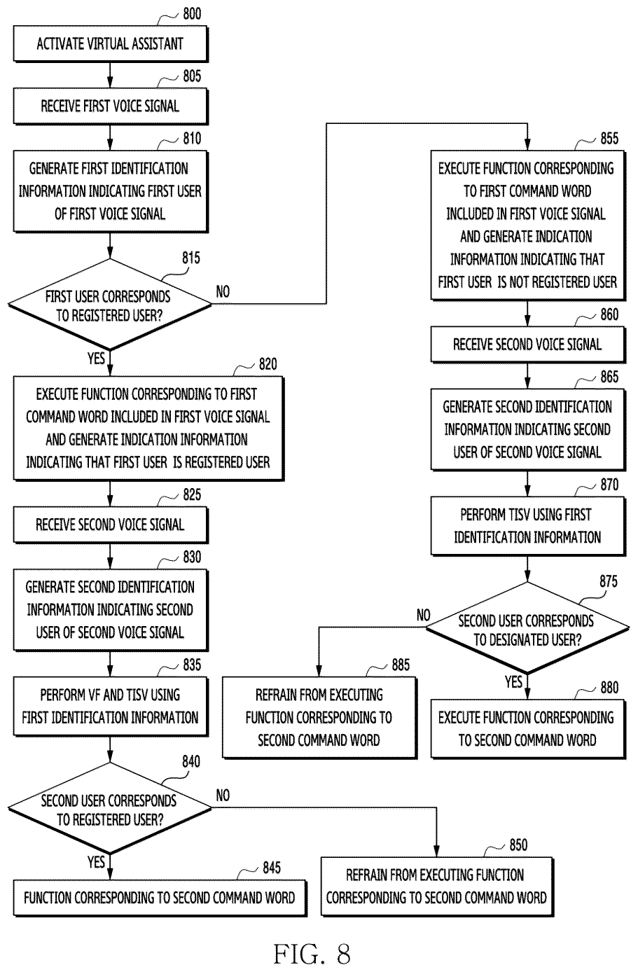

In the example, it is illustrated that the TISV 375 uses one reference identification information (e.g., the first identification information), but the present disclosure is not limited thereto. For example, the TISV 375 may use reference identification information indicating a temporarily allowed user (e.g., the first identification information above) and reference identification information indicating a registered user, as a reference. Accordingly, the TISV 375 may be used to determine whether the second user who uttered the second voice signal corresponds to a temporary allowed user or a registered user. In this case, the second voice signal provided to the TISV 375 may be a second voice signal received through the input interface 320 (or a second voice signal that is not filtered through the VF 380). Specific content related thereto is exemplified and described below with reference to FIG. 8.

As a non-limiting example, the electronic device 101 may provide the second voice signal to a personal VAD 385 using the first identification information as reference identification information. As a non-limiting example, the second voice signal provided to the personal VAD 385 may be a second voice signal filtered through the VF 380 as described above. Alternatively, as a non-limiting example, the second voice signal provided to the personal VAD 385 may be a second voice signal received through the input interface 320 (or second voice signal that is not filtered through the VF 380). For example, the personal VAD 385 may detect a second voice signal indicating a voice portion uttered by the first user within the second voice signal, based on the second voice signal. According to whether the detected second voice signal outputted from the personal VAD 385 includes a voice portion uttered by the first user, the electronic device 101 may determine whether the second user who uttered the second voice signal corresponds to the first user.

In operation 735, according to an embodiment, the electronic device 101 may determine whether an identified user corresponds to a designated user. For example, the electronic device 101 may determine whether the second user identified in operation 730 is the designated user. For example, the designated user may include a user registered for the virtual assistant and a user (e.g., the first user) temporarily allowed for the virtual assistant.

In operation 735, when the second user is the designated user, the electronic device 101 may perform operation 725. According to an embodiment, in operation 735, the electronic device 101 may perform operation 710 when the second user is not the designated user.

In operation 725, the electronic device 101 may execute a function corresponding to a command word. For example, when the second user corresponds to the first user, which is a temporarily allowed user, or a registered user, the electronic device 101 may execute a function corresponding to the command word of the second voice signal. After performing operation 725, the electronic device 101 may perform operation 710 again.

In FIG. 7, for convenience of explanation, an operation of determining whether a preset time duration is expired is omitted in relation to reception of a voice signal including a command word, but the present disclosure is not limited thereto. For example, the electronic device 101 may start a timer for the preset time duration from a timing when the virtual assistant is activated or a timing when execution of a function corresponding to a command word is completed. Accordingly, when a voice signal including a command word is received before the timer is expired, the timer may be initialized. According to an embodiment, when the timer is expired, the electronic device 101 may deactivate the virtual assistant. For example, the electronic device 101 may adjust a length of the preset time duration in a menu for setting the virtual assistant application 350. According to an embodiment, when the user uses the electronic device 101 or is looking at the electronic device 101, the electronic device 101 may increase the length of the preset time duration or initialize the timer.

In the above example, for convenience of explanation, it is assumed that the first user who uttered the first voice signal, which is the initial voice signal, is not a registered user but a temporarily allowed user, but the present disclosure is not limited thereto. For example, the first user may be a registered user. Even when the first user is a registered user, the electronic device 101 may determine whether the second user who uttered the second voice signal corresponds to the first user, by using the temporarily generated first identification information as a reference of the trained model.

In an example, the electronic device 101 may determine whether to use the first identification information as a reference of the trained model, by further determining whether the first user is a registered user. For example, in operation 720, the electronic device 101 may generate the first identification information indicating the first user who uttered the first voice signal. Thereafter, the electronic device 101 may perform similarity value identification (e.g., the similarity value identification 435 of FIG. 4C) through the TISV 375 and a comparison 437 with a reference value, based on the first identification information. In this case, reference identification information used as a reference for identifying the similarity value of the TISV 375 may be identification information indicating a registered user. In this case, the identification information indicating the registered user may be identification information stored in the memory 340 (or the identification information set 390). When a similarity value between the first identification information and the identification information indicating the registered user is greater than or equal to the reference value, the electronic device 101 may refrain from using (or not use) the first identification information as a reference of the trained model. For example, the electronic device 101 may delete the first identification information. When the similarity value between the first identification information and the identification information indicating the registered user is less than the reference value, the electronic device 101 may store (or cache, temporarily store) the first identification information in the memory 340 for using as a reference of the trained model.

In the example of FIG. 7, the electronic device 101 may delete the first identification information indicating the temporarily allowed first user. For example, the electronic device 101 may delete the stored first identification information in accordance with identifying a specified event. For example, the specified event may include at least one of deactivation of the activated virtual assistant, deactivation of a continuous command function of the virtual assistant, or identification that the first user indicated by the first identification information coincides with the user registered with the virtual assistant.

As a non-limiting example, when a screen (or execution screen) displayed when executed in the foreground of the virtual assistant application 350 is displayed in a minimum state and displayed in the minimum state for a specified time, the electronic device 101 may deactivate the activated virtual assistant. As a non-limiting example, when another application is executed according to execution of a function corresponding to a command word received based on the activated virtual assistant, and the other application uses the input interface 320, the electronic device 101 may deactivate the activated virtual assistant. For example, the other application may include a phone application, a video call application, or a voice recording application. As a non-limiting example, when media content (e.g., music or video) is played according to execution of a function corresponding to a command word received based on the activated virtual assistant, the electronic device 101 may deactivate the activated virtual assistant. As a non-limiting example, when the virtual assistant application 350 being executed in the foreground is executed in the background, the electronic device 101 may deactivate the activated virtual assistant. For example, the execution of the virtual assistant application 350 within the background may be performed according to an input (e.g., home key) for entry into a home screen application of the electronic device 101 or an input (e.g., back key) for entry into a previous execution screen (or previously executed application). As a non-limiting example, when a display of the electronic device 101 is in an off state (or a low-power consumption state), the electronic device 101 may deactivate the activated virtual assistant. For example, in the low power consumption state, an always on display (AOD) screen may be displayed. As a non-limiting example, when receiving a command word for deactivating the virtual assistant, the electronic device 101 may deactivate the activated virtual assistant. For example, the command word for deactivation may include “Goodbye”, “End”, and “Cancel”. As a non-limiting example, when a timer for the preset time duration is expired, the electronic device 101 may deactivate the activated virtual assistant. As a non-limiting example, when a connected communication network is disconnected (or when an airplane mode is executed), the electronic device 101 may deactivate the activated virtual assistant. However, in an example, when the virtual assistant application may provide a service without a communication network, the activation of the virtual assistant may be maintained.

As a non-limiting example, when the timer for the preset time duration is expired, the electronic device 101 may terminate a continuous command function of the virtual assistant. In other words, when the virtual assistant is deactivated, the electronic device 101 may terminate the continuous command function of the virtual assistant. As a non-limiting example, when another application is executed according to execution of a function corresponding to a command word received based on the activated virtual assistant, and the other application uses the input interface 320, the electronic device 101 may terminate the continuous command function of the virtual assistant. As a non-limiting example, when playing TTS composite sound is ceased while the TTS composite sound is played according to execution of a function corresponding to a command word received based on the activated virtual assistant, the electronic device 101 may terminate the continuous command function of the virtual assistant. As a non-limiting example, in accordance with identifying an input for an execution screen (or dialog window) (e.g., the screen 119 of FIG. 1A) of the virtual assistant application 350, the electronic device 101 may terminate the continuous command function of the virtual assistant. As a non-limiting example, when receiving a command word for terminating the continuous command function of the virtual assistant, the electronic device 101 may terminate the continuous command function of the virtual assistant. As a non-limiting example, when a connected communication network is disconnected (or when the airplane mode is executed), the electronic device 101 may terminate the continuous command function of the virtual assistant.

FIG. 8 illustrates an example of an operation flow for a method of verifying a second user who uttered a second voice signal and a method of executing a function corresponding to a command word of the second voice signal, according to whether a first user who uttered a first voice signal corresponds to a registered user in a continuous command function of a virtual assistant.

At least a portion of the method of FIG. 8 may be performed by the electronic device 101 of FIG. 3. For example, at least a portion of the method may be configured to be performed (or controlled) by at least one processor 310 of the electronic device 101. In the following embodiment, each operation may be performed sequentially, but is not necessarily performed sequentially. For example, the sequence of each operation may be changed, and at least two operations may be performed in parallel.

According to an embodiment, before performing operation 800, the electronic device 101 may register (or store) a user with respect to a virtual assistant. For example, the user may be referred to as a registered user. In addition, the electronic device 101 may execute the virtual assistant application 350 in the background.

In operation 800, according to an embodiment, the electronic device 101 may activate a virtual assistant. For example, when a wake-up word is recognized in the received voice signal, the electronic device 101 may activate the virtual assistant. For example, in response to an input (or user input) to the electronic device 101, the electronic device 101 may activate the virtual assistant. For example, the input may include an input to a physical button of the electronic device 101 or a visual object (or icon) displayed through a display of the electronic device 101. For example, the electronic device 101 may execute a continuous command function of the activated virtual assistant.

In operation 805, according to an embodiment, the electronic device 101 may receive a first voice signal. For example, the electronic device 101 may receive the first voice signal through the input interface 320.

In operation 810, according to an embodiment, the electronic device 101 may generate first identification information indicating a first user of the first voice signal. For example, the first identification information may be generated through the speaker feature extraction model 370 of FIG. 4A. As a non-limiting example, the first identification information may be generated based on the first voice signal. In an example, the first identification information may include a speaker feature vector (or a vector value) generated based on the first voice signal. For example, the first identification information may be used to temporarily allow the first user who uttered the first voice signal, which is a voice signal initially received after the virtual assistant is activated.

In operation 815, according to an embodiment, the electronic device 101 may determine whether the first user corresponds to a registered user. For example, the electronic device 101 may perform similarity value identification (e.g., the similarity value identification 435 of FIG. 4C) through the TISV 375 and a comparison 437 with a reference value, based on the first identification information. In this case, reference identification information used as a reference for identifying the similarity value of the TISV 375 may be identification information indicating a registered user. In this case, the identification information indicating the registered user may be identification information stored in the memory 340 (or the identification information set 390). When a similarity value between the first identification information and the identification information indicating the registered user is greater than or equal to the reference value, the electronic device 101 may identify that the first user is the registered user. According to an embodiment, when the similarity value between the first identification information and the identification information indicating the registered user is less than the reference value, the electronic device 101 may identify that the first user is different from the registered user.

As a non-limiting example, in a case that the virtual assistant is activated through a wake-up word in operation 800, the registered user may be a user who uttered the identified wake-up word when recognizing the wake-up word. In other words, recognizing the wake-up word by the electronic device 101 may include identifying (or recognizing) a user who uttered the wake-up word by the electronic device 101.

In operation 815, when the first user is a registered user, the electronic device 101 may perform operation 820. According to an embodiment, in operation 815, when the first user is not a registered user, the electronic device 101 may perform operation 855.

In operation 820, according to an embodiment, the electronic device 101 may execute a function corresponding to a first command word included in the first voice signal and generate indication information indicating that the first user is a registered user. For example, the electronic device 101 may execute a function corresponding to the first command word included in the first voice signal. In addition, the electronic device 101 may generate indication information (e.g., the first value 439-1 of FIG. 4C) indicating that the first user is the registered user, as a result outputted through the TISV 375. As a non-limiting example, when the first user is the registered user, the electronic device 101 may delete the first identification information. However, the present disclosure is not limited thereto. For example, even when the first user is the registered user, the electronic device 101 may use the first identification information as a reference of the trained model.

As a non-limiting example, the electronic device 101 may provide a visual effect through a screen, by using the generated indication information. For example, the electronic device 101 may display a screen through a display of the electronic device 101, in response to a voice signal received from the first user. For example, the screen may include text indicating the first user (e.g., texts 1021 and 1022 of FIG. 10), or text indicating a command word (e.g., the first command word) included in the voice signal. For example, when the electronic device 101 generates the indication information indicating that the first user is the registered user, the electronic device 101 may apply a first visual effect to the screen, based on the generated indication information. In an example, the first visual effect may include at least one of an indicator (or text) indicating that the user is a registered user, a color of the text, a font of the text, or a size of the text.

In operation 825, according to an embodiment, the electronic device 101 may receive a second voice signal. For example, the electronic device 101 may receive the second voice signal subsequent to the first voice signal, while a continuous command function of the activated virtual assistant is executed.

In operation 830, according to an embodiment, the electronic device 101 may generate second identification information indicating a second user of the second voice signal. For example, the second identification information may be generated through the speaker feature extraction model 370 of FIG. 4A. As a non-limiting example, the second identification information may be generated based on the second voice signal. In an example, the second identification information may include a speaker feature vector (or vector value) generated based on the second voice signal.

In operation 835, according to an embodiment, the electronic device 101 may perform VF and TISV using the first identification information. For example, the electronic device 101 may provide the second voice signal to the VF 380 using the first identification information as reference identification information. For example, the electronic device 101 may provide the second voice signal to the TISV 375 using the first identification information as reference identification information.

In operation 840, according to an embodiment, the electronic device 101 may determine whether the second user corresponds to a registered user. For example, the electronic device 101 may perform similarity value identification (e.g., the similarity value identification 435 of FIG. 4C) through the TISV 375 and a comparison 437 with a reference value, based on the second identification information. In this case, reference identification information used as a reference for identifying the similarity value of the TISV 375 may be identification information indicating a registered user (or the first identification information). When a similarity value between the second identification information and the first identification information is greater than or equal to the reference value, the electronic device 101 may identify that the second user is the registered user. According to an embodiment, when the similarity value between the second identification information and the first identification information is less than the reference value, the electronic device 101 may identify that the second user is different from the registered user.

In operation 840, when the second user is the registered user, the electronic device 101 may perform operation 845. According to an embodiment, in operation 840, when the second user is different from the registered user, the electronic device 101 may perform operation 850.

In operation 845, according to an embodiment, the electronic device 101 may execute a function corresponding to a second command word. For example, when the second user is the same as the registered user (or the first user), the electronic device 101 may execute a function corresponding to the second command word of the second voice signal.

In operation 850, according to an embodiment, the electronic device 101 may refrain from executing a function corresponding to the second command word. For example, when the second user is different from the registered user (or the first user), the electronic device 101 may refrain from executing a function corresponding to the second command word of the second voice signal.

In operation 855, according to an embodiment, the electronic device 101 may execute a function corresponding to a first command word included in the first voice signal and generate indication information indicating that the first user is not a registered user. For example, the electronic device 101 may execute a function corresponding to the first command word included in the first voice signal. In addition, the electronic device 101 may generate indication information (e.g., the second value 439-2 of FIG. 4C) indicating that the first user is not the registered user, as a result outputted through the TISV 375. As a non-limiting example, when the first user is not the registered user, the electronic device 101 may store (or cache, or temporarily store) the first identification information in the memory 340.

As a non-limiting example, the electronic device 101 may provide a visual effect through a screen, by using the generated indication information. For example, the electronic device 101 may display a screen through a display of the electronic device 101, in response to a voice signal received from the first user. For example, the screen may include text (e.g., texts 1021 and 1022 of FIG. 10) indicating the first user, or text representing a command word (e.g., the first command word) included in the voice signal. For example, when the electronic device 101 generates the indication information indicating that the first user is not the registered user, the electronic device 101 may apply a second visual effect to the screen based on the generated indication information. In an example, the second visual effect may include at least one of an indicator (or text) indicating that the user is an unregistered user, a color of the text, a font of the text, or a size of the text. In the example, the second visual effect may be different from the first visual effect.

In operation 860, according to an embodiment, the electronic device 101 may receive a second voice signal. For example, the electronic device 101 may receive the second voice signal subsequent to the first voice signal, while the continuous command function of the activated virtual assistant is executed.

In operation 865, according to an embodiment, the electronic device 101 may generate second identification information indicating a second user of the second voice signal. For example, the second identification information may be generated through the speaker feature extraction model 370 of FIG. 4A. As a non-limiting example, the second identification information may be generated based on the second voice signal. In an example, the second identification information may include a speaker feature vector (or a vector value) generated based on the second voice signal.

In operation 870, according to an embodiment, the electronic device 101 may perform TISV using the first identification information. For example, the electronic device 101 may provide the second voice signal to the TISV 375 that uses the first identification information as reference identification information. Unlike operation 835, in operation 870, since the first user is different from the registered user, the first identification information indicating a temporarily allowed user and identification information indicating a registered user may be used as the reference identification information, so the VF 380 may be omitted. In other words, unlike the TISV 375 that performs verification whether it is the same user (or speaker) based on a plurality of users (or speakers), the VF 380 may not perform filtering for a plurality of users (or speakers).

In an example, the electronic device 101 may learn (or generate) the reference identification information using the TISV 375, based on the first identification information. For example, the electronic device 101 may perform the TISV 375 for the second voice signal, by using the learned reference identification information.

In operation 875, according to an embodiment, the electronic device 101 may determine whether the second user corresponds to a designated user. For example, the designated user may include a registered user and a temporarily allowed user. For example, the electronic device 101 may perform similarity value identification (e.g., the similarity value identification 435 of FIG. 4C) through the TISV 375 and a comparison 437 with a reference value, based on the second identification information. In this case, the reference identification information used as a reference for identifying the similarity value of the TISV 375 may be identification information (or the first identification information) indicating a registered user. When a similarity value between the second identification information and the first identification information is greater than or equal to the reference value, the electronic device 101 may identify that the second user is the designated user. According to an embodiment, when the similarity value between the second identification information and the first identification information is less than the reference value, the electronic device 101 may identify that the second user is different from the designated user.

In operation 875, when the second user is the designated user, the electronic device 101 may perform operation 880. According to an embodiment, in operation 875, when the second user is different from the designated user, the electronic device 101 may perform operation 885.

In operation 880, according to an embodiment, the electronic device 101 may execute a function corresponding to a second command word. For example, when the second user is the same as the designated user (e.g., the first user or the registered user), the electronic device 101 may execute a function corresponding to the second command word of the second voice signal.

In operation 885, according to an embodiment, the electronic device 101 may refrain from executing a function corresponding to the second command word. For example, when the second user is different from the designated user (e.g., the first user or the registered user), the electronic device 101 may refrain from executing a function corresponding to the second command word of the second voice signal.

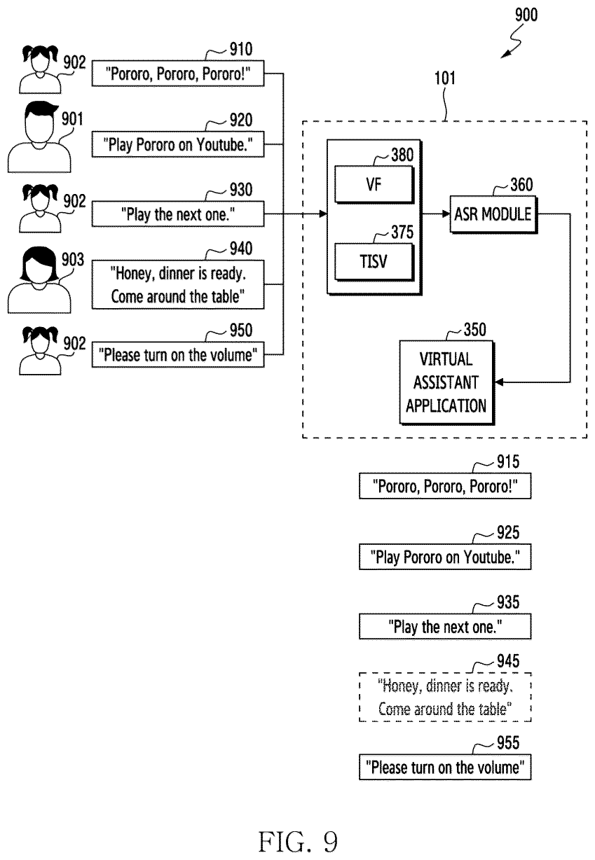

FIG. 9 illustrates an example of a method of recognizing a voice signal in a continuous command function of a virtual assistant based on temporary allow.

Referring to FIG. 9, an example 900 of a method in which the electronic device 101 recognizes a voice signal in a continuous command function of a virtual assistant based on temporary allow is illustrated. In the example 900, a user 901 may be a user registered with respect to the virtual assistant. In the example 900, a user 902 and a user 903 may be users who are not registered with respect to the virtual assistant.

Referring to the example 900, the electronic device 101 may activate a virtual assistant. For example, when a wake-up word is recognized in the received voice signal, the electronic device 101 may activate the virtual assistant. For example, the electronic device 101 may activate the virtual assistant in response to an input (or user input) to the electronic device 101. For example, the input may include an input to a physical button of the electronic device 101 or a visual object (or icon) displayed through a display of the electronic device 101. For example, the electronic device 101 may execute a continuous command function of the activated virtual assistant.

For example, the electronic device 101 may receive a plurality of voice signals 910, 920, 930, 940, and 950 through the input interface 320, while the continuous command function is executed. For example, the voice signals 910, 920, 930, 940, and 950 may be received through the input interface 320 in the order of the voice signal 910, the voice signal 920, the voice signal 930, the voice signal 940, and the voice signal 950. For example, the voice signal 910 may be “Pororo, Pororo, Pororo!” uttered by the user 902. For example, the voice signal 920 may be a “Play Pororo on YouTube” uttered by the user 901. For example, the voice signal 930 may be “Play the next one” uttered by the user 902. For example, the voice signal 940 may be “Honey, dinner is ready, come around the table” uttered by the user 903. For example, the voice signal 950 may be “Please turn on the volume” uttered by user 902.

For example, the electronic device 101 may generate identification information indicating the user 902 who uttered the voice signal 910 initially received after the virtual assistant is activated. For example, the electronic device 101 may recognize the user 902 as a temporarily allowed user.

For example, the electronic device 101 may recognize, from among voice signals 910, 920, 930, 940, and 950, voice signals 910, 930, and 950 of the user 902 who is a temporarily allowed user, and the voice signal 920 of the user 901 who is a registered user, and may reject the recognition for the voice signal 940 of the user 903. For example, the electronic device 101 may recognize, from among the voice signals 910, 920, 930, 940, and 950, voice signals 910, 930, and 950 of a user 902 who is a temporarily allowed user and the voice signal 920 of the user 901 who is a registered user through the VF 380 and/or the TISV 375. For example, the electronic device 101 may process recognized voice signals 910, 920, 930, and 950 through the ASR module 360. The electronic device 101 may provide the voice signals 910, 920, 930, and 950) processed through the ASR module 360 to the virtual assistant application 350. Accordingly, the virtual assistant application 350 may recognize voice signals 915, 925, 935, and 955, from among voice signals 915, 925, 935, 945, and 955. At this time, the voice signal 945 may not be provided to the virtual assistant application 350 as it is rejected through the VF 380 and/or the TISV 375.

The virtual secretary application 350 may identify a command word of each of voice signals 915, 925, 935, and 955 and execute a function corresponding to the identified command word.

As a non-limiting example, the electronic device 101 may further include a module for utterance discard. For example, the module for utterance discard may be stored in the memory 340 of the electronic device 101. For example, the module for utterance discard may analyze text(s) from voice signal(s) received through the input interface 320 through the ASR module 360, while the continuous command function is executed. For example, the module for utterance discard may identify text (hereinafter, discarded text) that does not need to execute a function corresponding to a command word based on the virtual assistant, in accordance with the analysis of the text. According to an embodiment, in the example 900, an example of the discarded text may be the voice signal 940 uttered by the user 903. In other words, the discarded text may be a voice signal rather than a command word for causing execution of a specific function by the virtual assistant. As a non-limiting example, the module for utterance discard may be implemented as an LLM (or utilize an LLM) to identify (or determine) the discarded text. For example, when the electronic device 101 determines the discarded text through the module for utterance discard, it may be considered that a voice signal corresponding to the discarded text is not received. In an example, even when a voice signal corresponding to the discarded text is received before a timer for a preset time duration starts and expires, the electronic device 101 may refrain from initializing the timer (or may not perform initialization).

FIG. 10 illustrates an example of a user interface for a setting related to a continuous command function of a virtual assistant.

FIG. 10 illustrates an example of a user interface 1000 for setting of a virtual assistant application 350. For example, the user interface 1000 may be referred to as a screen (or an execution screen).

For example, the electronic device 101 may display the user interface 1000 through a display of the electronic device 101. For example, the user interface 1000 may be a user interface for setting related to a continuous command function of a virtual assistant. As a non-limiting example, the user interface 1000 may include a first setting menu 1010, a second setting menu 1020, and a third setting menu 1030.

For example, the first setting menu 1010 may be a menu for activating and deactivating a continuous command function. For example, the first setting menu 1010 may include a toggle 1015 for activating and deactivating a continuous command function. For example, the toggle 1015 may be referenced as an executable object or an icon.

For example, the second setting menu 1020 may be a menu for registering and deleting a user (or speaker) who will allow a continuous command while the continuous command function is executed. For example, a registered (or added) user in the second setting menu 1020 may be a user registered with respect to the virtual assistant. For example, the second setting menu 1020 may include texts 1021 and 1022 that display currently registered users. For example, the second setting menu 1020 may include a button 1023 for newly adding a user who will allow a continuous command. For example, the button 1023 may be referenced as an executable object or an icon. Text indicating an added user based on at least one input to the button 1023 may be displayed within the second settings menu 1020, such as texts 1021 and 1022 of the second settings menu 1020.

For example, the third setting menu 1030 may be a menu for setting the number of users (or speakers) to temporarily allow a continuous command while the continuous command function is executed. For example, the number of users set in the third setting menu 1030 may be users who temporarily allowed with respect to the virtual assistant. For example, the third setting menu 1030 may include a button 1035 for changing (or adjusting) the number of users to be temporarily allowed. For example, the button 1035 may be referenced as an executable object or an icon. For example, the button 1035 may include text indicating the number of users currently temporarily allowed (e.g., 2).

The user interface 1000 illustrated in FIG. 10 is merely an example for convenience of explanation, and the present disclosure is not limited thereto. For example, the user interface 1000 may further include another setting menu, or may omit at least a portion of setting menus 1010, 1020, and 1030 illustrated in FIG. 10.

FIG. 11 is a block diagram illustrating an electronic device 1101 in a network environment 1100 according to various embodiments.

Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module may also be referred to as an input interface. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, a SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or U-plane latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

For example, the external electronic device 1102 may render content data executed in an application and transmit it to the electronic device 1101, and the electronic device 1101 that receives the data may output the content data to the display module. When the electronic device 1101 detects user movement through the IMU sensor, the processor of the electronic device 1101 may correct the rendering data received from the external electronic device 1102 based on the movement information and output it to the display module. Alternatively, it may transmit the movement information to the external electronic device 1102 and request rendering so that the screen data is updated accordingly. According to various embodiments, the external electronic device 1102 may be various types of device, such as a smartphone or a case device capable of storing and charging the electronic device 1101.

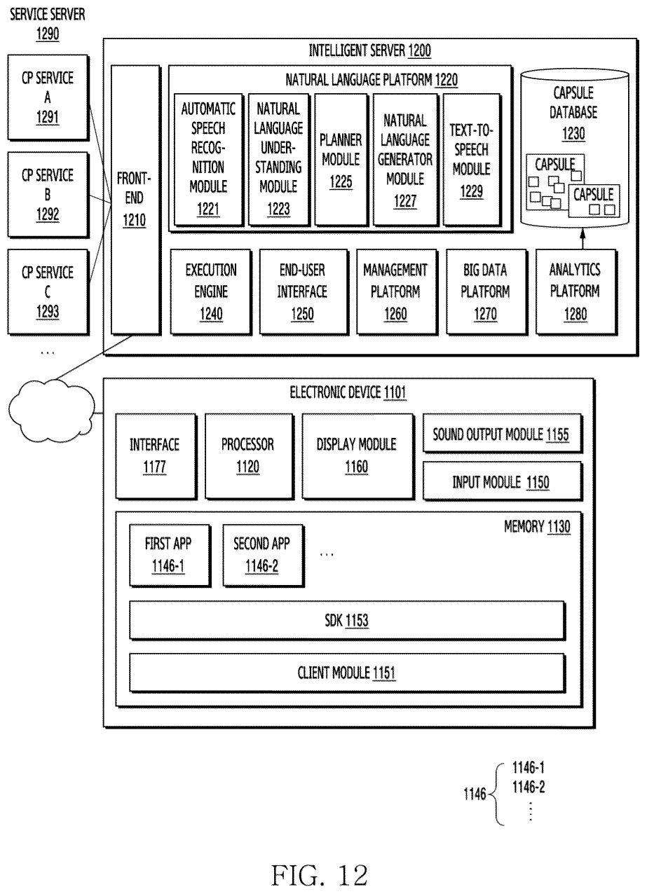

FIG. 12 is a block diagram illustrating an integrated intelligence system according to various embodiments.

Referring to FIG. 12, an integrated intelligent system according to an embodiment may include an electronic device 101, an intelligent server 1200 (e.g., the server 1108 of FIG. 11), and a service server 1290 (e.g., the server 1108 of FIG. 11).

The electronic device 1101 according to an embodiment may be a terminal device (or electronic device) connectable to the Internet, and for example, may be a mobile phone, a smart phone, a personal digital assistant (PDA), a notebook computer, a TV, white home appliance, a wearable device, an HMD, or a smart speaker.

According to an embodiment, the electronic device 1101 may include an interface 1177, an input module 1150, an audio output module 1155, a display module 1160, memory 1130, or a processor 1120. The components listed above may be operably or electrically connected to each other.

The interface 1177 according to an embodiment may be configured to be connected to an external device to transmit and receive data. The input module 1150 according to an embodiment may receive sound (e.g., user utterance) and convert it into an electrical signal. The audio output module 1155 according to an embodiment may output the electrical signal as sound (e.g., voice).

The display module 1160 according to an embodiment may be configured to display an image or video. The display module 1160 according to an embodiment may also display a graphic user interface (GUI) of an app (or application program) being executed. The display module 1160 according to an embodiment may receive a touch input through a touch sensor. For example, the display module 1160 may receive a text input through a touch sensor of an on-screen keyboard area displayed in the display module 1160.

The memory 1130 according to an embodiment may store a client module 1151, a software development kit (SDK) 1153, and a plurality of apps 1146. The client module 1151 and the SDK 1153 may configure a framework (or, a solution program) for performing a general function. In addition, the client module 1151 or the SDK 1153 may configure a framework for processing a user input (e.g., voice input, text input, touch input).

The plurality of apps 1146 stored in the memory 1130 according to an embodiment may be programs for performing a specified function. According to an embodiment, the plurality of apps 1146 may include a first app 1146-1 and a second app 1146-2. According to an embodiment, each of the plurality of apps 1146 may include a plurality of operations for performing a specified function. For example, the apps may include an alarm app, a message app, and/or a schedule app. According to an embodiment, the plurality of apps 1146 may be executed by the processor 1120 to sequentially execute at least a portion of the plurality of operations.

The processor 1120 according to an embodiment may control the overall operation of the electronic device 1101. For example, the processor 1120 may be electrically connected to the interface 1177, the input module 1150, the audio output module 1155, and the display module 1160 to perform a specified operation.

The processor 1120 according to an embodiment may also execute a program stored in the memory 1130 to perform a specified function. For example, the processor 1120 may perform the following operation for processing a user input, by executing at least one of the client module 1151 or the SDK 1153. For example, the processor 1120 may control operations of the plurality of apps 1146 through the SDK 1153. The following operation described as an operation of the client module 1151 or the SDK 1153 may be an operation by execution of the processor 1120.

The client module 1151 according to an embodiment may receive a user input. For example, the client module 1151 may receive a voice signal corresponding to a user utterance detected through the input module 1150. Alternatively, the client module 1151 may receive a touch input detected through the display module 1160. Alternatively, the client module 1151 may receive a text input detected through a keyboard or an on-screen keyboard. In addition, various types of user input detected through an input module included in the electronic device 1101 or an input module connected to the electronic device 1101 may be received. The client module 1151 may transmit the received user input to the intelligent server 1200. The client module 1151 may transmit state information of the electronic device 1101 to the intelligent server 1200, together with the received user input. For example, the state information may be execution state information of an app.

The client module 1151 according to an embodiment may receive a result corresponding to the received user input. For example, when the intelligent server 1200 may calculate a result corresponding to the received user input, the client module 1151 may receive a result corresponding to the received voice input. The client module 1151 may display the received result on the display module 1160. In addition, the client module 1151 may output the received result as audio through the sound output module 1155.

The client module 1151 according to an embodiment may receive a plan corresponding to the received user input. The client module 1151 may display, on the display module 1160, a result of executing a plurality of operations of the app according to the plan. For example, the client module 1151 may sequentially display an execution result of the plurality of operations on the display and output audio through the sound output module 1155. For another example, the electronic device 1101 may display only a portion (e.g., a result of the last operation) of a result of executing the plurality of operations on the display module 1160, and output it as audio through the sound output module 1155.

According to an embodiment, the client module 1151 may receive a request for obtaining information necessary to calculate a result corresponding to a user input from the intelligent server 1200. According to an embodiment, the client module 1151 may transmit the necessary information to the intelligent server 1200, in response to the request.

The client module 1151 according to an embodiment may transmit result information obtained by executing the plurality of operations according to the plan to the intelligent server 1200. The intelligent server 1200 may identify that a received user input has been correctly processed by using the result information.

The client module 1151 according to an embodiment may include a voice recognition module. According to an embodiment, the client module 1151 may recognize a voice input that performs a limited function through the voice recognition module. For example, the client module 1151 may perform an intelligent app for processing a voice input to perform an organic operation through a specified input (e.g., wake-up!).

The intelligent server 1200 according to an embodiment may receive information related to a user voice input from the electronic device 101 through a communication network. According to an embodiment, the intelligent server 1200 may change data related to the received voice input into text data. According to an embodiment, the intelligent server 1200 may generate a plan for performing a task corresponding to a user voice input, based on the text data.

According to an embodiment, the plan may be generated by an artificial intelligence (AI) system. The AI system may be a rule-based system, a neural network-based system (e.g., a feedforward neural network (FNN), or a recurrent neural network (RNN)). According to an embodiment, the AI system may be a combination of the above or another AI system. According to an embodiment, a plan may be selected from a set of predefined plans, or may be generated in real time in response to a user request. For example, the AI system may select at least one plan from among a plurality of predefined plans.

The intelligent server 1200 according to an embodiment may transmit a result in accordance with the generated plan to the electronic device 1101, or transmit the generated plan to the electronic device 1101. According to an embodiment, the electronic device 1101 may display, on the display module 1160, the result in accordance with the plan. According to an embodiment, the electronic device 1101 may display, on the display module 1160, a result of executing an operation in accordance with a plan.

The intelligent server 1200 according to an embodiment may include a front end 1210, a natural language platform 1220, a capsule DB 1230, an execution engine 1240, an end user interface 1250, a management platform 1260, a big data platform 1270, or an analytic platform 1280.

The front end 1210 of an embodiment may receive a user input received from the electronic device 101. The front end 1210 may transmit a response corresponding to the user input.

According to an embodiment, the natural language platform 1220 may include an automatic speech recognition module (ASR module) 1221, a natural language understanding module (NLU module) 1223, a planner module (1225), a natural language generator module (NLG module) 1227, or a text to speech module (TTS module) 1229.

The ASR module 1221 according to an embodiment may convert a voice input received from the electronic device 1101 into text data. The NLU module 1223 according to an embodiment may identify the user's intent by using the text data of the voice input. For example, the NLU module 1223 may identify the user's intent by performing syntactic analysis or semantic analysis on a user input in a form of text data. The NLU module 1223 according to an embodiment may identify a meaning of a word extracted from a user input by using linguistic features (e.g., grammatical elements) of a morpheme or a phrase, and may determine the user's intent by matching the identified meaning of the word to the intent. The NLU module 1223 may obtain intent information corresponding to the user's utterance. The intent information may be information indicating the user's intent determined by interpreting text data. The intent information may include information indicating an operation or a function that the user intends to execute using the device.

The planner module 1225 according to an embodiment may generate a plan using the intent and parameter determined in the NLU module 1223. According to an embodiment, the planner module 1225 may determine a plurality of domains necessary to perform a task based on the determined intent. The planner module 1225 may determine a plurality of actions included in each of a plurality of domains determined based on the intent. According to an embodiment, the planner module 1225 may determine a parameter necessary to execute the plurality of determined actions, or a result value outputted by the execution of the plurality of actions. The parameter and the result value may be defined as a concept of a specified format (or class). Accordingly, the plan may include a plurality of actions and a plurality of concepts, which are determined by the user's intent. The planner module 1225 may determine a relationship between the plurality of actions and the plurality of concepts in a stepwise (or hierarchical) manner. For example, the planner module 1225 may determine an execution order of the plurality of actions determined based on the user's intent based on the plurality of concepts. In other words, the planner module 1225 may determine the execution order of the plurality of actions, based on a parameter required for the execution of the plurality of actions and a result outputted by the execution of the plurality of actions. Accordingly, the planner module 1225 may generate a plan including association information (e.g., ontology) between the plurality of actions and the plurality of concepts. The planner module 1225 may generate a plan using information stored in a capsule database 1230 in which a set of relationships between concepts and actions is stored.

The NLG module 1227 according to an embodiment may change a specified information into text form. The information changed into text form may be in a form of natural language speech. The TTS module 1229 according to an embodiment may change information in text form into information in voice form.

According to an embodiment, some or all of functions of the natural language platform 1220 may also be implemented in the electronic device 1101.

The capsule database 1230 may store information on a relationship between actions and a plurality of concepts corresponding to a plurality of domains. According to an embodiment, a capsule may include a plurality of action objects (or action information) and concept objects (or concept information) included in a plan. According to an embodiment, the capsule database 1230 may store a plurality of capsules in a form of a concept action network (CAN). According to an embodiment, the plurality of capsules may be stored in a function registry included in the capsule database 1230.

The capsule database 1230 may include a strategy registry in which strategy information required for determining a plan corresponding to a voice input is stored. The strategy information may include reference information for determining one plan when a plurality of plans corresponding to user inputs are present. According to an embodiment, the capsule database 1230 may include a follow-up registry in which information of follow-up actions for suggesting follow-up actions to a user in a specified situation is stored. For example, the follow-up action may include a follow-up utterance. According to an embodiment, the capsule database 1230 may include a layout registry that stores layout information of information outputted through the electronic device 1101. According to an embodiment, the capsule database 1230 may include a vocabulary registry that stores vocabulary information included in capsule information. According to an embodiment, the capsule database 1230 may include a dialog registry in which information on a dialog (or interaction) with a user is stored. The capsule database 1230 may update stored an object through a developer tool. For example, the developer tool may include a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with a user. The developer tool may include a follow up editor for activating a follow up goal and editing a follow up utterance that provides a hint. The follow up goal may be determined based on a currently set goal, a user preference, or an environmental condition. In an embodiment, the capsule database 1230 may also be implemented within the electronic device 1101.

The execution engine 1240 according to an embodiment may calculate a result by using the generated plan. The end user interface 1250 may transmit the calculated result to the electronic device 1101. Accordingly, the electronic device 1101 may receive the result and provide the received result to the user. The management platform 1260 according to an embodiment may manage information used in the intelligent server 1200. The big data platform 1270 according to an embodiment may collect user data. The analytic platform 1280 according to an embodiment may manage a quality of service (QoS) of the intelligent server 1200. For example, the analytic platform 1280 may manage a component and a processing speed (or efficiency) of the intelligent server 1200.

The service server 1290 according to an embodiment may include a CP service A 1291, a CP service B 1292, and a CP service C 1293. The service server 1290 according to an embodiment may provide a specified service (e.g., food ordering or hotel reservation) to the electronic device 1101. According to an embodiment, the service server 1290 may be a server operated by a third party. The service server 1290 according to an embodiment may provide, to the intelligent server 1200, information for generating a plan corresponding to a received user input. The provided information may be stored in the capsule database 1230. In addition, the service server 1290 may provide result information according to the plan to the intelligent server 1200.

In the integrated intelligence system of FIG. 12, the electronic device 1101 may provide various intelligent services to the user in response to a user input. For example, the user input may include an input through a physical button, a touch input, or a voice input.

In an embodiment, the electronic device 1101 may provide a voice recognition service through an intelligent app (or a voice recognition app) stored therein. In this case, for example, the electronic device 1101 may recognize a user utterance or a voice input received through the microphone and provide a service corresponding to the recognized voice input to the user.

In an embodiment, the electronic device 1101 may perform a specified operation, based on the received voice input, alone or together with the intelligent server and/or the service server. For example, the electronic device 1101 may execute an app corresponding to the received voice input and perform a specified operation through the executed app.

In an embodiment, when the electronic device 1101 provides a service together with the intelligent server 1200 and/or the service server 1290, the electronic device 1101 may detect a user's utterance by using the input module 1150 and generate a signal (or voice data) corresponding to the detected user's utterance. The electronic device 1101 may transmit the voice data to the intelligent server 1200 by using the interface 1177.

The intelligent server 1200 according to an embodiment may generate, as a response to a voice input received from the electronic device 1101, a plan for performing a task corresponding to the voice input, or a result of performing an operation according to the plan. For example, the plan may include a plurality of operations for performing a task corresponding to a user's voice input, and a plurality of concepts related to the plurality of operations. The concept may define a parameter inputted by the execution of the plurality of operations, or a result value outputted by the execution of the plurality of operations. The plan may include association information between the plurality of operations and the plurality of concepts.

The electronic device 1101 according to an embodiment may receive the response using the interface 1177. The electronic device 1101 may output a voice signal generated inside the electronic device 1101 to the outside by using the audio output module 1155, or may output an image generated inside the electronic device 1101 to the outside by using the display module 1160.

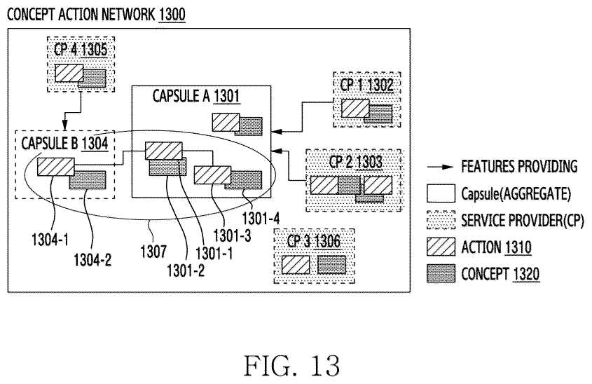

FIG. 13 is a diagram illustrating a form in which relationship information between a concept and an operation is stored in a database according to various embodiments.

The capsule database (e.g., the capsule database 1230 of FIG. 12) of the intelligent server (e.g., the intelligent server 1200 of FIG. 12) may store a capsule in a form of a concept action network (CAN) 1300. The capsule database may store actions for processing a task corresponding to a user's voice input and a parameter necessary for the actions in the form of a concept action network (CAN).

The capsule database may store a plurality of capsules (e.g., capsule A 1301, capsule B 1304) corresponding to each of a plurality of domains (e.g., applications). According to an embodiment, one capsule (e.g., the capsule A 1301) may correspond to one domain (e.g., geo application). In addition, one capsule may correspond to at least one service provider (e.g., CP 1 1302, CP 2 1303, CP 3 1306, or CP 4 1305) for performing a function for a domain related to a capsule. According to an embodiment, one capsule may include at least one action 1310 for performing a specified function and at least one concept 1320.

The natural language platform (e.g., the natural language platform 1220 of FIG. 12) may generate a plan for performing a task corresponding to a voice input received using a capsule stored in a capsule database. For example, a planner module (e.g., the planner module 1225 of FIG. 12) of the natural language platform may generate a plan by using a capsule stored in a capsule database. For example, a plan 1307 may be generated using actions 1301-1 and 1301-3 and concepts 1301-2 and 1301-4 of the capsule A 1301 and an action 1304-1 and a concept 1304-2 of the capsule B 1304.

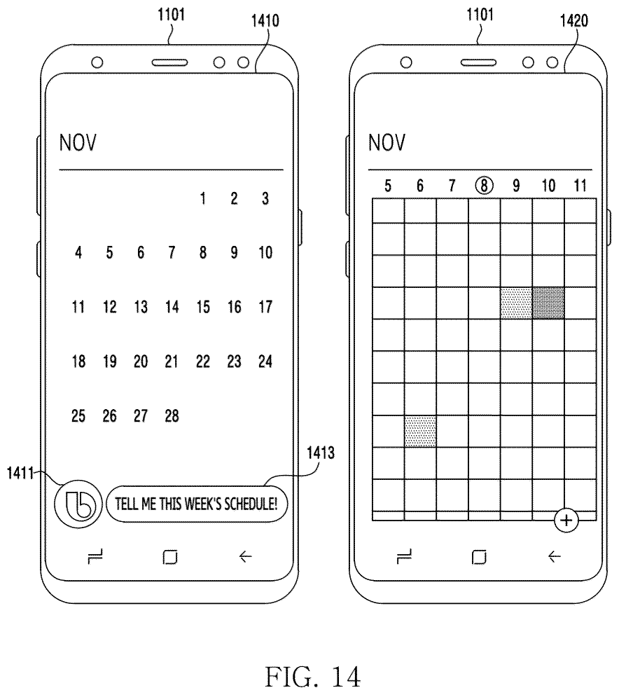

FIG. 14 is a diagram illustrating a screen in which an electronic device processes a voice input received through an intelligent app according to various embodiments.

The electronic device 1101 may execute an intelligent app to process a user input through an intelligent server (e.g., the intelligent server 1200 of FIG. 12).

According to an embodiment, in the screen 1410, when recognizing a specified voice input (e.g., wake up!) or receiving an input through a hardware key (e.g., a dedicated hardware key), the electronic device 1101 may execute an intelligent app for processing the voice input. For example, the electronic device 1101 may execute an intelligent app in a state of executing a schedule app. According to an embodiment, the electronic device 1101 may display an object (e.g., icon) 1411 corresponding to an intelligent app on a display module (e.g., the display module 1160 of FIG. 11). According to an embodiment, the electronic device 1101 may receive a voice input by a user's utterance. For example, the electronic device 1101 may receive a voice input such as “Tell me this week's schedule!”. According to an embodiment, the electronic device 1101 may display, on a display module (e.g., the display module 1160 of FIG. 11), a user interface (UI) 1413 (e.g., input window) of an intelligent app in which text data of the received voice input is displayed.

According to an embodiment, in the screen 1420, the electronic device 1101 may display a result corresponding to the received voice input on a display module (e.g., the display module 1160 of FIG. 11). For example, the electronic device 1101 may receive a plan corresponding to the received user input and display ‘this week's schedule’ on the display module 1160 according to the plan.

The technical problems to be achieved in this document are not limited to those described above, and other technical problems not mentioned herein will be clearly understood by those having ordinary knowledge in the art to which the present disclosure belongs, from the following description.

As described above, an electronic device 101 may comprise an input interface 320. The electronic device 101 may comprise memory 340, including one or more storage media, storing instructions. The electronic device 101 may comprise at least one processor 310 including processing circuitry. The instructions, when executed by the at least one processor 310 individually or collectively, may cause the electronic device 101 to, based on a virtual assistant being activated, receive, through the input interface 320, a first voice signal including a first command word. The instructions, when executed by the at least one processor 310 individually or collectively, may cause the electronic device 101 to, based on the first voice signal, generate first identification information indicating a first speaker of the first voice signal. The instructions, when executed by the at least one processor 310 individually or collectively, may cause the electronic device 101 to execute a function corresponding to the first command word of the first voice signal. The instructions, when executed by the at least one processor 310 individually or collectively, may cause the electronic device 101 to, receive, through the input interface 320, a second voice signal including a second command word after the first voice signal. The instructions, when executed by the at least one processor 310 individually or collectively, may cause the electronic device 101 to, based on the second voice signal, generate second identification information indicating a second speaker of the second voice signal. The instructions, when executed by the at least one processor 310 individually or collectively, may cause the electronic device 101 to, based on a similarity value between the first identification information and the second identification information being greater than or equal to a reference value, execute a function corresponding to the second command word of the second voice signal.

According to an embodiment, the instructions, when executed by the at least one processor 310 individually or collectively, may cause the electronic device 101 to activate the virtual assistant. The instructions, when executed by the at least one processor 310 individually or collectively, may cause the electronic device 101 to execute a continuous command function of the activated virtual assistant. The instructions, when executed by the at least one processor 310 individually or collectively, may cause the electronic device 101 to, while the continuous command function of the virtual assistant is executed, receive the first voice signal and the second voice signal. The activation of the virtual assistant may be performed based on at least one of reception of a voice signal including a wake-up word through the input interface 320 or reception of an input for activating the virtual assistant.

According to an embodiment, the first voice signal may be a voice signal initially received through the input interface 320 after the virtual assistant is activated.

According to an embodiment, the instructions, when executed by the at least one processor 310 individually or collectively, may cause the electronic device 101 to provide, to a first trained model 370 for speaker feature extraction, the first voice signal. The instructions, when executed by the at least one processor 310 individually or collectively, may cause the electronic device 101 to generate, through the first trained model 370, the first identification information. The first identification information may comprise a vector value indicating the first speaker.

According to an embodiment, the instructions, when executed by the at least one processor 310 individually or collectively, may cause the electronic device 101 to, based on the similarity value being less than the reference value, refrain from executing the function corresponding to the second command word of the second voice signal.

According to an embodiment, the second voice signal may be received through the input interface 320 after the function corresponding to the first command word of the first voice signal is completed, and before a preset time duration is expired, or may be received through the input interface 320 while the function corresponding to the first command word of the first voice signal is executed. The function corresponding to the first command word of the first voice signal may comprise playing text to speech (TTS) synthesized sound.

According to an embodiment, the instructions, when executed by the at least one processor 310 individually or collectively, may cause the electronic device 101 to provide, to a first trained model 370 for speaker feature extraction, the second voice signal. The instructions, when executed by the at least one processor 310 individually or collectively, may cause the electronic device 101 to generate, through the first trained model 370, the second identification information. The instructions, when executed by the at least one processor 310 individually or collectively, may cause the electronic device 101 to provide, to a second trained model 375 for speaker verification using the first identification information, the second identification information. The instructions, when executed by the at least one processor 310 individually or collectively, may cause the electronic device 101 to identify, through the second trained model 375, the similarity value between the first identification information and the second identification information. The first identification information may comprise a vector value indicating the first speaker. The second identification information may comprise a vector value indicating the second speaker.

According to an embodiment, the instructions, when executed by the at least one processor 310 individually or collectively, may cause the electronic device 101 to, before the activation of the virtual assistant, store third identification information indicating a speaker registered with respect to the virtual assistant. The instructions, when executed by the at least one processor 310 individually or collectively, may cause the electronic device 101 to identify, through the second trained model 375 using the third identification information, a similarity value between the generated first identification information and the third identification information.

According to an embodiment, the instructions, when executed by the at least one processor 310 individually or collectively, may cause the electronic device 101 to, based on the similarity value between the first identification information and the third identification information being greater than or equal to the reference value, provide, to a third trained model 380 for voice filter using the first identification information or the third identification information, the received second voice signal. The instructions, when executed by the at least one processor 310 individually or collectively, may cause the electronic device 101 to, based on the similarity value between the first identification information and the third identification information being greater than or equal to the reference value, generate, through the third trained model 380, a filtered second voice signal. The instructions, when executed by the at least one processor 310 individually or collectively, may cause the electronic device 101 to, based on the similarity value between the first identification information and the third identification information being greater than or equal to the reference value, provide, to the first trained model 370, the filtered second voice signal.

According to an embodiment, the instructions, when executed by the at least one processor 310 individually or collectively, may cause the electronic device 101 to, based on the similarity value between the first identification information and the third identification information being less than the reference value, refrain from providing, to a third trained model 380 for voice filter using the first identification information or the third identification information, the received second voice signal. The instructions, when executed by the at least one processor 310 individually or collectively, may cause the electronic device 101 to, based on the similarity value between the first identification information and the third identification information being less than the reference value, provide, to the first trained model 370, the second voice signal.

According to an embodiment, the instructions, when executed by the at least one processor 310 individually or collectively, may cause the electronic device 101 to identify, through the second trained model 375 using the third identification information, a similarity value between the second identification information and the third identification information. The instructions, when executed by the at least one processor 310 individually or collectively, may cause the electronic device 101 to, based on the similarity value between the first identification information and the third identification information being less than the reference value and based on the similarity value between the second identification information and the third identification information being greater than or equal to the reference value, execute the function corresponding to the second command word of the second voice signal. The instructions, when executed by the at least one processor 310 individually or collectively, may cause the electronic device 101 to, based on the similarity value between the first identification information and the second identification information being less than the reference value and based on the similarity value between the second identification information and the third identification information being less than the reference value, refrain from executing the function corresponding to the second command word of the second voice signal.

According to an embodiment, the instructions, when executed by the at least one processor 310 individually or collectively, may cause the electronic device 101 to store, in the memory 340, the generated first identification information. The instructions, when executed by the at least one processor 310 individually or collectively, may cause the electronic device 101 to, in accordance with identifying a specified event, delete, from the memory 340, the stored first identification information. The specified event may comprise at least one of a deactivation of the activated virtual assistant, a deactivation of a continuous command function of the virtual assistant, or an identification that the first speaker indicated by the first identification information coincides with a speaker registered with respect to the virtual assistant.

According to an embodiment, the instructions, when executed by the at least one processor 310 individually or collectively, may cause the electronic device 101 to provide, to a fourth trained model 385 for voice activity detection, the second voice signal. The instructions, when executed by the at least one processor 310 individually or collectively, may cause the electronic device 101 to detect, through the fourth trained model 385, a voice duration of the second command word in the second voice signal. The instructions, when executed by the at least one processor 310 individually or collectively, may cause the electronic device 101 to, based on the second command word in the detected voice duration, generate the second identification information.

As described above, a method performed by an electronic device 101 with a input interface 320 may comprise, based on a virtual assistant being activated, receiving, through the input interface 320, a first voice signal including a first command word. The method may comprise, based on the first voice signal, generating first identification information indicating a first speaker of the first voice signal. The method may comprise executing a function corresponding to the first command word of the first voice signal. The method may comprise receiving, through the input interface 320, a second voice signal including a second command word after the first voice signal. The method may comprise, based on the second voice signal, generating second identification information indicating a second speaker of the second voice signal. The method may comprise, based on a similarity value between the first identification information and the second identification information being greater than or equal to a reference value, executing a function corresponding to the second command word of the second voice signal.

As described above, a non-transitory computer-readable storage medium, when individually or collectively executed by at least one processor 310 of an electronic device 101 with an input interface 320, may store one or more programs including instructions that cause the electronic device 101 to, based on a virtual assistant being activated, receive, through the input interface 320, a first voice signal including a first command word. The non-transitory computer-readable storage medium, when individually or collectively executed by the at least one processor 310, may store one or more programs including instructions that cause the electronic device 101 to, based on the first voice signal, generate first identification information indicating a first speaker of the first voice signal. The non-transitory computer-readable storage medium, when individually or collectively executed by the at least one processor 310, may store one or more programs including instructions that cause the electronic device 101 to execute a function corresponding to the first command word of the first voice signal. The non-transitory computer-readable storage medium, when individually or collectively executed by the at least one processor 310, may store one or more programs including instructions that cause the electronic device 101 to receive, through the input interface 320, a second voice signal including a second command word after the first voice signal. The non-transitory computer-readable storage medium, when individually or collectively executed by the at least one processor 310, may store one or more programs including instructions that cause the electronic device 101 to, based on the second voice signal, generate second identification information indicating a second speaker of the second voice signal. The non-transitory computer-readable storage medium, when individually or collectively executed by the at least one processor 310, may store one or more programs including instructions that cause the electronic device 101 to, based on a similarity value between the first identification information and the second identification information being greater than or equal to a reference value, execute a function corresponding to the second command word of the second voice signal.

As described above, an electronic device 101 may comprise an input interface 320. The electronic device 101 may comprise memory 340, including one or more storage media, storing instructions. The electronic device 101 may comprise at least one processor 310 including processing circuitry. The instructions, when executed by the at least one processor 310 individually or collectively, may cause the electronic device 101 to, based on a virtual assistant being activated, receive, through the input interface 320, a first voice signal including a first command word. The instructions, when executed by the at least one processor 310 individually or collectively, may cause the electronic device 101 to, based on the first voice signal, generate identification information indicating a first speaker of the first voice signal. The instructions, when executed by the at least one processor 310 individually or collectively, may cause the electronic device 101 to execute a function corresponding to the first command word of the first voice signal. The instructions, when executed by the at least one processor 310 individually or collectively, may cause the electronic device 101 to receive, through the input interface 320, a second voice signal including a second command word after the first voice signal. The instructions, when executed by the at least one processor 310 individually or collectively, may cause the electronic device 101 to, based on the second voice signal and the identification information, identify whether the first speaker is corresponding to a second speaker of the second voice signal. The instructions, when executed by the at least one processor 310 individually or collectively, may cause the electronic device 101 to, in accordance with identifying that the first speaker is corresponding to the second speaker, execute a function corresponding to the second command word of the second voice signal. The instructions, when executed by the at least one processor 310 individually or collectively, may cause the electronic device 101 to, in accordance with identifying that the first speaker is not corresponding to the second speaker, refrain from executing the function corresponding to the second command word of the second voice signal.

According to an embodiment, the instructions, when executed by the at least one processor 310 individually or collectively, may cause the electronic device 101 to activate the virtual assistant. The instructions, when executed by the at least one processor 310 individually or collectively, may cause the electronic device 101 to execute a continuous command function of the activated virtual assistant. The instructions, when executed by the at least one processor 310 individually or collectively, may cause the electronic device 101 to, while the continuous command function of the virtual assistant is executed, receive the first voice signal and the second voice signal. The activation of the virtual assistant may be performed based on at least one of reception of a voice signal including a wake-up word through the input interface 320 or reception of an input for activating the virtual assistant.

According to an embodiment, the instructions, when executed by the at least one processor 310 individually or collectively, may cause the electronic device 101 to provide, to a first trained model 370 for speaker feature extraction, the first voice signal. The instructions, when executed by the at least one processor 310 individually or collectively, may cause the electronic device 101 to generate, through the first trained model 370, the identification information. The identification information may comprise a vector value indicating the first speaker.

According to an embodiment, the instructions, when executed by the at least one processor 310 individually or collectively, may cause the electronic device 101 to provide, to the first trained model 370, the second voice signal. The instructions, when executed by the at least one processor 310 individually or collectively, may cause the electronic device 101 to generate, through the first trained model 370, another identification information indicating the second speaker. The instructions, when executed by the at least one processor 310 individually or collectively, may cause the electronic device 101 to provide, to a second trained model 375 for speaker verification using the identification information, the other identification information. The instructions, when executed by the at least one processor 310 individually or collectively, may cause the electronic device 101 to identify, through the second trained model 375, a similarity value between the identification information and the other identification information. The instructions, when executed by the at least one processor 310 individually or collectively, may cause the electronic device 101 to, based on the similarity value being greater than or equal to a reference value, identify that the first speaker is corresponding to the second speaker. The instructions, when executed by the at least one processor 310 individually or collectively, may cause the electronic device 101 to, based on the similarity value being less than the reference value, identify that the first speaker is not corresponding to the second speaker. The other identification information may comprise a vector value indicating the second speaker.

According to an embodiment, the instructions, when executed by the at least one processor 310 individually or collectively, may cause the electronic device 101 to provide, to a third trained model 385 for voice activity detection using the identification information, the second voice signal. The instructions, when executed by the at least one processor 310 individually or collectively, may cause the electronic device 101 to identify, in accordance with detecting a voice duration of the second command word in the second voice signal through the third trained model 385, that the first speaker is corresponding to the second speaker. The instructions, when executed by the at least one processor 310 individually or collectively, may cause the electronic device 101 to identify, in accordance with not detecting the voice duration of the second command word in the second voice signal through the third trained model 385, that the first speaker is not corresponding to the second speaker.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
an input interface configured to receive sound data;
memory comprising one or more storage media storing instructions; and
at least one processor comprising processing circuitry,
wherein the instructions, when executed by the at least one processor individually or collectively, cause the electronic device to:
based on a virtual assistant being activated, receive a first voice signal including a first command through the input interface;
based on the first voice signal, generate first identification information corresponding to a first speaker of the first voice signal;
execute a function corresponding to the first command of the first voice signal;
receive a second voice signal including a second command after the first voice signal through the input interface;
based on the second voice signal, generate second identification information corresponding to a second speaker of the second voice signal; and
based on a similarity value between the first identification information and the second identification information being greater than or equal to a reference value, execute a function corresponding to the second command of the second voice signal.

2. The electronic device of claim 1, wherein the instructions, when executed by the at least one processor individually or collectively, cause the electronic device to:
activate the virtual assistant;
execute a continuous command function of the activated virtual assistant; and
in a state in which the continuous command function of the virtual assistant is being executed, receive the first voice signal and the second voice signal, and
wherein the virtual assistant is activated based on at least one of receiving a voice signal including a wake-up command through the input interface or receiving an input for activating the virtual assistant.

3. The electronic device of claim 1, wherein the first voice signal is a voice signal including a command first received through the input interface after the virtual assistant is activated.

4. The electronic device of claim 1, wherein the instructions, when executed by the at least one processor individually or collectively, cause the electronic device to:
provide the first voice signal to a first trained model that is configured to perform speaker feature extraction; and
generate the first identification information through the first trained model, and
wherein the first identification information comprises a vector value corresponding to the first speaker.

5. The electronic device of claim 1, wherein the instructions, when executed by the at least one processor individually or collectively, cause the electronic device to:
based on the similarity value being less than the reference value, refrain from executing the function corresponding to the second command of the second voice signal.

6. The electronic device of claim 1, wherein the second voice signal is:
received through the input interface after the function corresponding to the first command of the first voice signal is executed, and before a preset time duration is expired, or
received through the input interface in a state in which the function corresponding to the first command of the first voice signal is being executed, and
wherein the function corresponding to the first command of the first voice signal is configured to play a text to speech (TTS) synthesized sound.

7. The electronic device of claim 1, wherein the instructions, when executed by the at least one processor individually or collectively, cause the electronic device to:
provide the second voice signal to a first trained model that is configured to perform speaker feature extraction;
generate the second identification information through the first trained model;
provide the second identification information to a second trained model that is configured to perform speaker verification; and
identify the similarity value between the first identification information and the second identification information through the second trained model,
wherein the first identification information comprises a vector value corresponding to the first speaker, and
wherein the second identification information comprises a vector value corresponding to the second speaker.

8. The electronic device of claim 7, wherein the instructions, when executed by the at least one processor individually or collectively, cause the electronic device to:
prior to activating the virtual assistant, store third identification information corresponding to a speaker that is registered with the virtual assistant; and
identify a similarity value between the first identification information and the third identification information through the second trained model.

9. The electronic device of claim 8, wherein the instructions, when executed by the at least one processor individually or collectively, cause the electronic device to:
based on the similarity value between the first identification information and the third identification information being greater than or equal to the reference value:
provide the second voice signal to a third trained model that is configured to perform voice filtering using the first identification information or the third identification information;
generate a filtered second voice signal through the third trained model; and
provide the filtered second voice signal to the first trained model.

10. The electronic device of claim 8, wherein the instructions, when executed by the at least one processor individually or collectively, cause the electronic device to:
based on the similarity value between the first identification information and the third identification information being less than the reference value:
refrain from providing the second voice signal to a third trained model that is configured to perform voice filtering using the first identification information or the third identification information; and
provide the second voice signal to the first trained model.

11. The electronic device of claim 8, wherein the instructions, when executed by the at least one processor individually or collectively, cause the electronic device to:
identify a similarity value between the second identification information and the third identification information through the second trained model;
based on the similarity value between the first identification information and the second identification information being less than the reference value, and based on the similarity value between the second identification information and the third identification information being greater than or equal to the reference value, execute the function corresponding to the second command of the second voice signal; and
based on the similarity value between the first identification information and the second identification information being less than the reference value, and based on the similarity value between the second identification information and the third identification information being less than the reference value, refrain from executing the function corresponding to the second command of the second voice signal.

12. The electronic device of claim 1, wherein the instructions, when executed by the at least one processor individually or collectively, cause the electronic device to:
store the first identification information in the memory; and
based on a specified event, delete the stored first identification information from the memory, and
wherein the specified event comprises at least one of a deactivation of the activated virtual assistant, a deactivation of a continuous command function of the virtual assistant, or an identification that the first speaker corresponding to the first identification information coincides with a speaker registered with the virtual assistant.

13. The electronic device of claim 1, wherein the instructions, when executed by the at least one processor individually or collectively, cause the electronic device to:
provide the second voice signal to a fourth trained model that is configured to perform voice activity detection;
detect a voice duration of the second command in the second voice signal through the fourth trained model; and
based on the second command in the detected voice duration, generate the second identification information.

14. A method performed by an electronic device including an input interface configured to receive sound data, the method comprising:
based on a virtual assistant being activated, receiving a first voice signal including a first command through the input interface;
based on the first voice signal, generating first identification information corresponding to a first speaker of the first voice signal;
executing a function corresponding to the first command of the first voice signal;
receiving a second voice signal including a second command after the first voice signal through the input interface;
based on the second voice signal, generating second identification information corresponding to a second speaker of the second voice signal; and
based on a similarity value between the first identification information and the second identification information being greater than or equal to a reference value, executing a function corresponding to the second command of the second voice signal.

15. A non-transitory computer-readable storage medium stores one or more programs including instructions that, when individually or collectively executed by at least one processor of an electronic device that includes an input interface configured to receive sound data, cause the electronic device to:
based on a virtual assistant being activated, receive a first voice signal including a first command through the input interface;
based on the first voice signal, generate first identification information corresponding to a first speaker of the first voice signal;
execute a function corresponding to the first command of the first voice signal;
receive a second voice signal including a second command after the first voice signal through the input interface;
based on the second voice signal, generate second identification information corresponding to a second speaker of the second voice signal; and
based on a similarity value between the first identification information and the second identification information being greater than or equal to a reference value, execute a function corresponding to the second command of the second voice signal.

16. An electronic device comprising:
an input interface configured to receive sound data;
memory comprising one or more storage media storing instructions; and
at least one processor comprising processing circuitry,
wherein the instructions, when executed by the at least one processor individually or collectively, cause the electronic device to:
based on a virtual assistant being activated, receive a first voice signal including a first command through the input interface;
based on the first voice signal, generate identification information corresponding to a first speaker of the first voice signal;
execute a function corresponding to the first command of the first voice signal;
receive a second voice signal including a second command after the first voice signal through the input interface;
based on the second voice signal and the identification information, identify whether the first speaker corresponds to a second speaker of the second voice signal;
based on the first speaker corresponding to the second speaker, execute a function corresponding to the second command of the second voice signal; and
based on the first speaker not corresponding to the second speaker, refrain from executing the function corresponding to the second command of the second voice signal.

17. The electronic device of claim 16, wherein the instructions, when executed by the at least one processor individually or collectively, cause the electronic device to:
activate the virtual assistant;
execute a continuous command function of the activated virtual assistant; and
in a state in which the continuous command function of the virtual assistant is being executed, receive the first voice signal and the second voice signal, and
wherein the virtual assistant is activated based on at least one of receiving a voice signal including a wake-up command through the input interface or receiving an input for activating the virtual assistant.

18. The electronic device of claim 16, wherein the instructions, when executed by the at least one processor individually or collectively, cause the electronic device to:
provide the first voice signal to a first trained model configured to perform speaker feature extraction; and
generate the identification information through the first trained model, and
wherein the identification information comprises a vector value corresponding to the first speaker.

19. The electronic device of claim 18, wherein the instructions, when executed by the at least one processor individually or collectively, cause the electronic device to:
provide the second voice signal to the first trained model;
generate second identification information corresponding to the second speaker through the first trained model;
provide the second identification information to a second trained model that is configured to perform speaker verification;
identify a similarity value between the identification information and the second identification information through the second trained model;
based on the similarity value being greater than or equal to a reference value, identify that the first speaker is corresponding to the second speaker; and
based on the similarity value being less than the reference value, identify that the first speaker is not corresponding to the second speaker, and
wherein the second identification information comprises a vector value corresponding to the second speaker.

20. An electronic device comprising:
an input interface configured to receive sound data;
memory comprising one or more storage media storing instructions; and
at least one processor comprising processing circuitry,
wherein the instructions, when executed by the at least one processor individually or collectively, cause the electronic device to:
activate a virtual assistant;
based on receiving a first voice signal including a first command through the input interface in a state in which the virtual assistant is activated, generate first identification information corresponding to a first speaker of the first voice signal;
execute a function corresponding to the first command of the first voice signal;
based on receiving, after the first voice signal, a second voice signal including a second command through the input interface in the state in which the virtual assistant is activated, generate second identification information corresponding to a second speaker of the second voice signal; and
based on a similarity between the first identification information and the second identification information, execute a function corresponding to the second command of the second voice signal.
